(19) United States
(12) Patent Application Publication
(10) Pub. No.: US 2026/0065245 A1
(43) Pub. Date: Mar. 5, 2026

(54) SERVER-SIDE DETECTION OF SUBSCRIPTION TRANSACTIONS WITH MACHINE LEARNING INTEGRATION FOR TEMPORARY SUBSCRIPTION-BASED BLOCKS

(71) Applicant: Capital One Services, LLC, McLean, VA (US)

(72) Inventors: Arjun Srihari, Ashburn, VA (US); Erik Virbitsky, Washington, DC (US); Girish Manchapanahalli, Fairfax, VA (US); Marisa Lee, Washington, DC (US); Sabrina Nijim, Alexandria, VA (US)

(21) Appl. No.: 19/384,671

(22) Filed: Nov. 10, 2025

Related U.S. Application Data
(63) Continuation-in-part of application No. 18/187,205, filed on Mar. 21, 2023.

(51) Int. Cl. G06Q 20/12; G06Q 20/40

(52) U.S. Cl. CPC G06Q 20/127; G06Q 20/407

(57) ABSTRACT

Systems, methods, and apparatuses for blocking subscription transactions for a given subscription from being applied to an electronic payment method, while allowing other transactions to be applied to the electronic payment method. Aspects further comprise training a machine learning model, based on historical transaction data, to predict subscription transactions, and updating the machine learning model based on incoming transactions. Aspects further provide for allowing a user to indicate they wish to cancel a subscription, blocking charges to the subscription while communicating with the merchant to cancel the subscription, and then removing the block after the subscription is confirmed canceled. to Aspects further provide for detecting when a subscription transaction was not blocked properly and updating the machine learning model to block similar subscription transactions in the future.

### CROSS-REFERENCE TO RELATED APPLICATION(S)

This instant application is a continuation-in-part of U.S. patent application Ser. No. 18/187,205 titled “Enabling Recurring Service Transactions Applied to An Electronic Payment Method to be Identified Based On Historical Transaction Data and Managing Services”, filed Mar. 21, 2023. The above-identified application is hereby incorporated by reference in its entirety.

### FIELD OF USE

Aspects of this disclosure relate to computer implemented systems and methods for determining, based on historical transaction data, that past charges for a service of a merchant to an electronic payment method of a user correspond to a subscription type recurring transaction, and providing a user with options to manage the service. More specifically, aspects of the disclosure provide for generating a probability, based on a machine learning model analyzing historical transaction data, that there will be an upcoming charge to the user's electronic payment method for a service of a merchant corresponding to a subscription type recurring transaction, based on the probability exceeding a threshold, allowing a user to manage the subscription.

### BACKGROUND

The popularity of recurring services including subscription services has risen in recent years. Furthermore, traditional types of subscription services that were popular in the past (e.g., newspaper and magazine subscriptions) have been joined and in some cases supplanted by newer types of subscription services. These newer types of subscription services include variations of older types of services as well as entirely new services some of which are electronic in nature (e.g., video streaming services and online gaming services). Further, the ways in which these services may be acquired and cancelled have changed over time. In the past, a user typically would have had to call a merchant/service provider's customer service center, which is open for limited hours such as regular business hours, to cancel or update a subscription. More recently, many subscription services can be updated or cancelled online by a user, with a web browser, going to a merchant's web site and logging in and navigating through several pages to in order to update or cancel their service. The increasing number of these services may contribute to an increase in situations in which a user loses track of the services to which that user is subscribed. For example, 1 in 3 users aged 25-54 have six or more subscription services.

As a result, users may end up inadvertently spending significant amounts of money in the form of unwanted subscription charges that are paid on a recurring basis. Not surprisingly, nearly half of users do not know the exact amount of money they are spending on subscriptions. However, to manage these unwanted services, a user may take the steps of canceling the service or altering their services via calling a customer service center or logging into the merchant's web site. Such methods of cancelling or updating a service can be time consuming, and require the user to know what services they have

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein may relate to determining, using a machine learning model on a first server trained to predict whether a transaction received at a server for an electronic payment method is a subscription transaction, one or more subscription transactions previously received at the first server for a first electronic payment method of a first user. Aspects described herein may further relate to determining, using the machine learning model and based on the one or more subscription transactions, that the first user has a first subscription at a first merchant, wherein the one or more subscription transactions correspond to one or more payments from the first electronic payment method to the first merchant for the first subscription. Aspects described herein may further relate to causing display of, by the first server and on a user device associated with the first user, an option to cancel the first subscription and receiving, based on first user input to the user device and at the first server, an indication to cancel the first subscription. Aspects described herein may further relate to sending, from the first server to a second server associated with the first merchant, a request to cancel the first subscription.

Aspects described herein may further relate to instituting a first block, wherein the first block is configured to stop incoming transactions for the first subscription. Stopping a first incoming transaction based on aspects described herein may relate to receiving, at the first server, the first incoming transaction for the first electronic payment method, determining, using the machine learning model, whether the first incoming transaction is from the first merchant, determining, using the machine learning model and based on the one or more subscription transactions corresponding to one or more payments for the first subscription, whether the first incoming transaction is for the first subscription. Aspects described herein may further relate to, based on the first block and based on determining that the first incoming transaction is for the first subscription, preventing the first incoming transaction from being applied to the first electronic payment method. Aspects described herein may further relate to receiving, at the first server and from the second server, an indication that the first subscription has been canceled by the first merchant, and removing the first block. Aspects described herein may further relate to notifying the first user that the first incoming transaction, based on the first block, was prevented from being applied to the first electronic payment method.

Aspects described herein may further relate to receiving, based on second user input to the user device and at the first server, an indication to cancel a second subscription of the one or more subscriptions, wherein the second subscription is associated with a second merchant, and sending, from the first server to a third server associated with the second merchant, a request to cancel the second subscription. Aspects described herein may further relate to instituting a second block, wherein the second block is configured to stop incoming transactions for the second subscription. Aspects described herein may further relate to receiving, at the first server and for the first electronic payment method, a second incoming transaction, and applying the second incoming transaction to the first electronic payment method and detecting, by the machine learning model, that the second incoming transaction is a subscription transaction for the second subscription and was not blocked. Aspects described herein may further relate to reversing the second incoming transaction from being applied to the first electronic payment method and updating, based on the second incoming transaction, the machine learning model. Aspects described herein may further relate to notifying, by the first server and on the user device, the first user that the second block failed to block transactions for the second subscription, and causing display of, by the first server and on the user device, an option to remove the second block.

Aspects described herein may further relate to causing display of, on the user device and by the first server, an option to reactivate the first subscription. Aspects described herein may further relate to receiving, based on third user input to the user device and on the first server, an indication to reactivate the first subscription, and sending, from the first server to the second server, a request to reactivate the first subscription. Aspects described herein may further relate to updating, based on the first incoming transaction, the machine learning model.

Corresponding apparatuses, devices, systems, and computer-readable media (e.g., non-transitory computer readable media) are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 illustrates an example of a computing system that may be used to implement one or more aspects of the disclosure in accordance with one or more illustrative aspects of the disclosure;

FIG. 2 illustrates an example system which may be used to one or more aspects of the disclosure in accordance with one or more illustrative aspects of the disclosure;

FIGS. 3A and 3B provides an illustrative flowchart representation of the process of determining whether historical transaction data corresponds to a recurring transaction and providing one or more subscription management options for managing the service corresponding to the recurring transaction according to one or more aspects of the disclosure;

FIG. 4 is an illustrative flowchart of a machine learning model determining a probability that the historical transaction data corresponds to a recurring transaction according to one or more aspects of the disclosure;

FIG. 5 is an illustrative flowchart of one aspect of FIG. 3, in which the machine learning model is trained using various training data according to one or more aspects of the disclosure;

FIG. 6A illustrates an example user interface display screen of a user's financial institution mobile app showing expected upcoming bills for recurring subscription type recurring transactions according to one or more aspects of the disclosure;

FIG. 6B illustrates an example user interface display screen of a user's financial institution mobile app showing selection of an example service management option (cancel service) and a further illustrative user interface display screen of an authorization form based on the selection of the cancel service option according to one or more aspects of the disclosure;

FIG. 6C illustrates an example user interface display screen of a user's financial institution mobile app showing an illustrative cancel pending confirmation generated based on a user submitting the illustrative authorization form in FIG. 6B according to one or more aspects of the disclosure.

FIG. 7 illustrates an example user interface display screen of a user's financial institution mobile app showing an illustrative block charges confirmation based on block charges management option having been selected according to one or more aspects of the disclosure;

FIG. 8A shows an example of an overlay that may appear on a user interface display screen of a user's financial institution mobile app based on a user selecting a pause service management option according to one or more aspects of the disclosure;

FIG. 8B shows an example of an overlay that may appear on a user interface display screen of a user's financial institution mobile app based on a user selecting an update service management option according to one or more aspects of the disclosure;

FIG. 8C illustrates an example user interface display screen of a user's financial institution mobile app showing an illustrative offer to not cancel service confirmation according to one or more aspects of the disclosure;

FIG. 9 illustrates an example user interface display screen of a user's financial institution mobile app showing an illustrative screen including upcoming transactions and inactive subscription services according to one or more aspects of the disclosure;

FIG. 10 is an illustrative flowchart representation of a machine learning model determining a probability that a user's historical transaction data including past charges indicate a subscription type recurring transaction according to one or more aspects of the disclosure;

FIG. 11 is an illustrative flowchart representation of the process for training a transaction identification model according to one or more aspects of the disclosure;

FIG. 12 is an illustrative flowchart of a process for blocking charges to a subscription after sending a cancellation request according to one or more aspects of the disclosure; and

FIG. 13 is an illustrative flowchart of a process for detecting subscription transactions that were not blocked according to one or more aspects of the disclosure.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

There has been an increase in the popularity of subscription services to which a user (e.g., a consumer) may subscribe and receive some goods and/or services on a fixed (e.g., a one year subscription that ends after one year) or open-ended basis (e.g., a month to month subscription that continues indefinitely or until canceled). These good or services may include subscriptions to online streaming media services, fitness club memberships, food delivery services, online gaming services, or any other goods or services to which a user may create a subscription and pay incoming charges for the service on a recurring basis. For example, a user may subscribe to a gaming service that charges an agreed upon amount on a monthly basis. While recurring payments for services is convenient and relieves the user of the burden of having to repeatedly perform the steps of manually paying for a service it may also create issues for the user. For example, it may be difficult for a user to keep track of the services to which the user is currently subscribed, and which services are recurring. Further, a user may lose track of services that are used infrequently or sporadically.

To manage a service subscription, such as to cancel or update a service, the user may call the merchant (or the merchant's customer service line) providing the service, log in to their account on the merchant's website or via a mobile application and navigate through several pages/screens. Financial institutions, which provide an electronic payment method (e.g., debit card or credit card), to which an incoming charge or upcoming charge for a recurring service is applied, in the past have provided no mechanism to allow a user to communicate with merchant to cancel or update their service. Financial institutions may comprise a bank, credit union, savings and loans, wealth management company or other entity that issues transaction cards usable for processing transactions for goods and services.

The financial institution can allow a user to block charges from a merchant, without notifying the merchant prior to the merchant attempting to obtain payment for an incoming charge as described in co-pending, U.S. patent application Ser. No. 18/086,836 filed Dec. 22, 2022 and co-pending U.S. patent application Ser. No. 18/051,705 filed Nov. 1, 2022, both of which are incorporated by reference herein.

In some instances, the financial institution can determine if the user has signed up for a trial for a service and provided an electronic payment method to be charged when a payment comes due for the service such as the end of the trial. When determining that a user has signed up for a trial, the financial institution may notify the user, prior to a payment coming due (e.g., end of the trial), that the electronic payment method is scheduled to be charged for the service and, provide the user with an option to block charges from the merchant. If the user requests to block charges from the merchant, the financial institution may place the merchant on a blocked merchant list. When transaction data including the incoming charge for the service is received from the merchant, the financial institution may determine, by a machine learning model and based on incoming charge data, that the incoming charge is most likely (e.g., a probability exceeding a threshold probability) from a merchant included in the blocked merchants list and based on determining that the charge is most likely from the merchant, the financial institution can provide the user with the ability to block the incoming charge from being applied to the electronic payment method.

In another example, when the incoming charge data is received from the merchant, the financial institution may determine, based on a machine learning model and the incoming charge data, a probability of the incoming charge being for a preauthorized recurring transaction from the merchant (rather than an unauthorized recurring transaction). If the probability exceeds a threshold probability, then the incoming charge will not be processed and blocked. Otherwise, if the probability does not exceed the threshold probability, then the incoming charge is not for a preauthorized recurring transaction and will be processed and not blocked.

According to the above examples in which the incoming charge is blocked and not processed, the merchant first learns that charges have not been processed when there is an attempt made to apply a charge for the service to the user's electronic payment method and the charge is declined. The financial institution sends notification of the declined charge to the merchant who typically will attempt to process the charge several more times. Ultimately, the merchant will need to contact the user, for example, via email or telephone to ultimately determine whether the user wishes to continue with the service or cancel the service. This is cumbersome for both the merchant and the user. For example, the user may not wish to speak with the merchant about their desire to cancel the service, and simply want to just cancel the service. It would be beneficial for the user if they could cancel the service, or take other actions, regarding the service, without the need to directly interact with the merchant such as via phone, merchant mobile app or merchant website.

In some instances, it may be advantageous to utilize a third party intermediary that provides APIs that allows a bank to provide its customers with subscription management options to manage their subscriptions from the bank mobile app. The third party intermediary may have established relationships with subscription business merchants where each merchant can choose one or more subscription management options to be made available for customers through the customer's financial institution. The third party intermediary can send the subscription management options available to a financial institution. The financial institution in turn can make the subscription management options available to their customers through their mobile app. A customer of the financial institution may select a subscription management option, and subscription management instruction may be sent, via the third party intermediary, to the merchant. Subscription management options that may be provided include options to allow a user to cancel subscriptions and recurring payments, upgrade or downgrade subscription plans, pause and resume subscriptions, update payment methods for subscriptions, and receive real-time offers at time of cancellation, and resubscribe.

While a third party intermediary may be configured to receive service management instructions from the user, via the financial institution, and then forward those instructions to the corresponding merchants, the third party intermediary does not have access to the historical transaction data of a user and thus does not have the ability to evaluate past transactions and thus cannot determine which of a user's past transactions for services correspond to subscription type recurring transactions. In some instances, the user may have conducted other recurring or non-recurring transactions provided by the same merchant (e.g., Google, Amazon, Microsoft). Thus, there is a need for the financial institution to determine if a particular service of the corresponding merchant is a particular recurring transaction to prevent the possibility of the wrong recurring transaction or a non-recurring transactions being managed (e.g., paused or canceled). The financial institution maintains historical transaction data including historical transaction data regarding a user's past transaction history and can train a machine learning model based on the user's transaction history. Probabilities may be generated, based on the machine learning model and historical transaction data, that past charges correspond to recurring transactions. By analyzing historical transaction data, a financial institution may apply a machine learning model to generate an accurate prediction to an upcoming charge. Also, a predicted amount of the upcoming charge prediction a predicted date when an upcoming charge will be applied to a user's electronic payment method can be generated by a computing device of the financial institution. Thus, the user can, via the financial institution mobile app, be presented with a list of upcoming charges for specific subscription services determined to be recurring transactions on the display of their mobile device separately from other transactions, and manage the subscription services by selecting a subscription management option such as pause, cancel, or update payment method.

Moreover, the financial institution must protect user historical transaction data with the highest levels of security to maintain user privacy and to otherwise comply with regulatory schemes. Practically, such historical transaction data cannot be made available to the third party intermediary. Additionally, the financial institution also has access to historical transaction data of other users, who employ an electronic payment method associated with the financial institution, for services of the same merchants. The financial institution may utilize that information, which is not available to the third party intermediary, to aid in analyzing whether a transaction corresponds to a recurring transaction or subscription type recurring transaction by, for example comparing aspects of other user's transaction details (e.g., merchant, service, charge amount, charge cadence) with aspects of the historical user transaction data. Further, the financial institution may evaluate various data fields such as a description field of the past transactions to determine if the past charges may be associated with ground truth labels indicating whether each of the past transactions is a subscription type recurring transaction rather than an instance in which a user has, for example, made a purchase on the same day for several consecutive weeks. These aspects of historical transaction data may further contribute to improving the accuracy of determining whether a transaction is recurring and whether a transaction is a subscription type recurring transaction.

It is virtually impossible for the third party intermediary to provide options for modifying all subscription related recurring transactions. However, the financial institution can identify all subscription related recurring transactions and provide at least the option to block charges (as disclosed in co-pending, U.S. patent application Ser. No. 18/086,836 filed Dec. 22, 2022 and co-pending U.S. patent application Ser. No. 18/051,705 filed Nov. 1, 2022) for services of merchants that the third party intermediary does not provide any options for managing the recurring transaction. That is, according to aspects of the disclosure, services associated with subscription type recurring transactions, whether or not supported by the third party intermediary, can managed.

All recurring transactions are not subscription type recurring transactions. For example, a user may make recurring purchases (e.g., payment for three meals purchased from the same restaurant on three consecutive Saturday evenings) that are not subscription type purchases. Subscription type services are charged to a previously designated (previously authorized by the user) electronic payment method of a user without the user having to manually make a payment time of a transaction at the regular cadence. The user may designate an electronic payment method at the time of signing up for the subscription type service, which may be required by certain subscription type service merchants, or during the period of service, at the user's discretion, should the user wish to have the service charge applied at a regular cadence rather than having to manually pay a bill at the regular cadence. The disclosed technology addresses and resolves these issues by leveraging the use of a machine learning model that is configured to determine the probability that past charges associated with a merchant are for a subscription type recurring transaction. The determined probability that the past charges correspond to a subscription type recurring transaction may then be used to determine whether an upcoming charge should be presented to the user to provide a user with one or more options to alter the service associated with the upcoming charge such as by canceling, pausing, or updating the service, or an option allowing the user to update the payment method for the service associated with the subscription type recurring transaction. Based on determining that past charges correspond to a subscription type recurring transactions of a merchant, a predicted upcoming charge amount and payment date for the upcoming charge can be presented to a user for managing their predicted upcoming transactions.

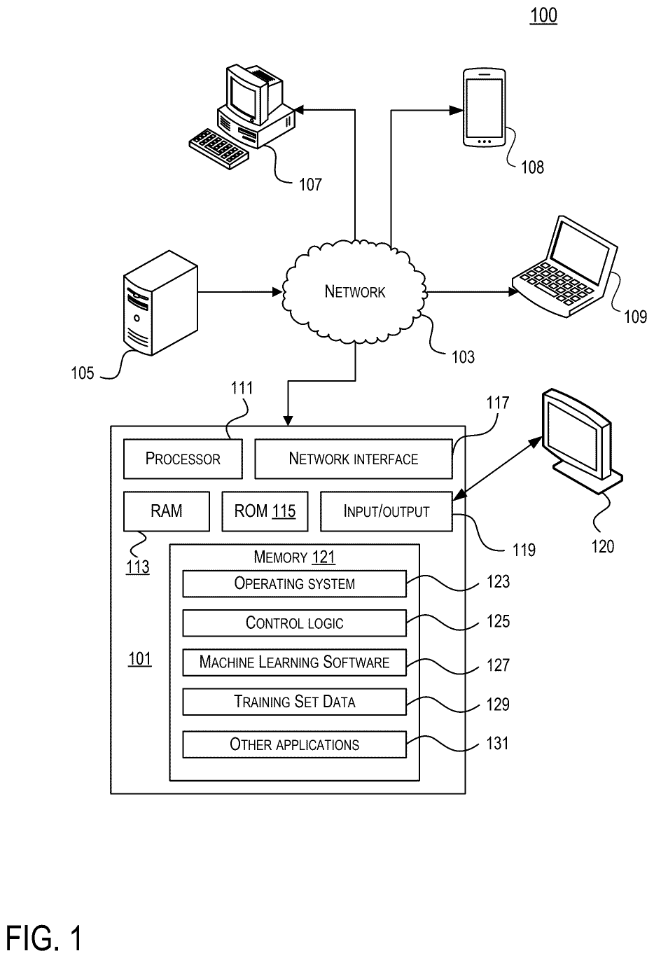

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading and/or executing instructions and performing one or more actions based on the instructions. In some embodiments, computing device 101 may represent, be incorporated in, and/or include various devices such as a desktop computer, a computer server, a mobile device (e.g., a laptop computer, a tablet computer, a smartphone, any other types of mobile computing devices, and the like), and/or any other type of data processing device.

Computing device 101 may, in some embodiments, operate in a standalone environment. In other embodiments, computing device 101 may operate in a networked environment. As shown in FIG. 1, various network nodes 101, 105, 107, 108, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topology and may use one or more of a variety of different protocols, such as Ethernet. Devices 101, 105, 107, 108, 109 and other devices (not shown) may be connected to one or more of the networks via twisted pair wires, coaxial cable, fiber optics, radio waves or other communication media.

As seen in FIG. 1, computing device 101 may include a processor 111, RAM 113, ROM 115, network interface 117, input/output interfaces (I/O) 119 (e.g., keyboard, mouse, display, printer, etc.), and memory 121. Processor 111 may include one or more computer processing units (CPUs), graphical processing units (GPUs), and/or other processing units such as a processor adapted to perform computations associated with machine learning. I/O 119 may include a variety of interface units and drives for reading, writing, displaying, and/or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, machine learning model 127 (e.g., software comprising instructions to implement a machine learning model), training dataset 129, and other applications 131. Control logic 125 may be incorporated in and may be a part of machine learning model 127. In other embodiments, computing device 101 may include two or more of any and/or all of these components (e.g., two or more processors, two or more memories, etc.) and/or other components and/or subsystems not illustrated here.

Devices 105, 107, 108, 109 may have similar or different architecture as described with respect to computing device 101. Those of skill in the art will appreciate that the functionality of computing device 101 (or device 105, 107, 108, 109) as described herein may be spread across multiple data processing devices, for example, to distribute processing load across multiple computers, to segregate transactions based on geographic location, user access level, quality of service (QoS), etc. For example, devices 101, 105, 107, 108, 109, and others may operate in concert to provide parallel computing features in support of the operation of control logic 125 and/or machine learning model 127.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

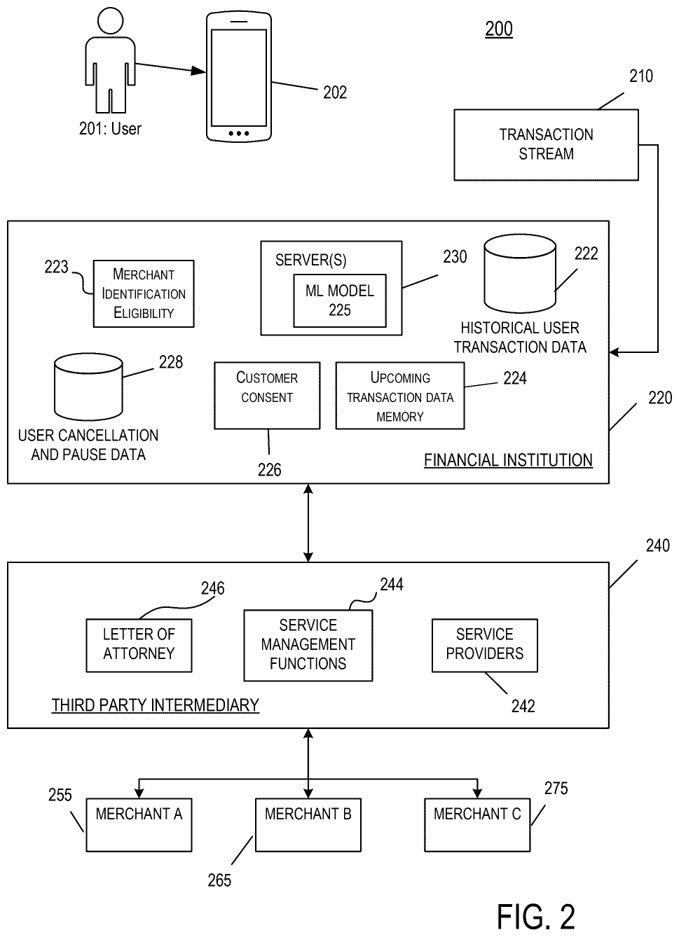

FIG. 2 depicts a diagram of an illustrative system 200, which may be employed according to certain aspects of the disclosure. The system 200 may include a mobile computing device such as mobile phone 202 of a customer or user 201, which is configured to execute a mobile app of financial institution 220, and customer (user) transaction stream 210 for incoming charges to an electronic payment method of the user. Further, the system 200 may include financial institution 220, third party intermediary 240, and a plurality of merchants such as merchant A 255, merchant B 265 and merchant C 275.

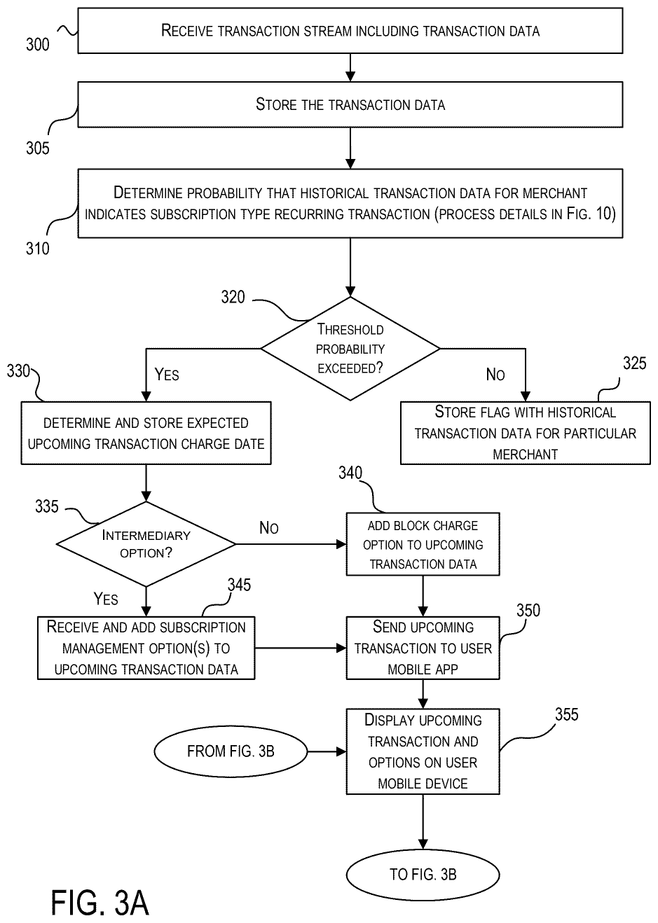

FIGS. 3A and 3B depict an illustrative method flow for determining whether historical transaction data of an individual user including past charges associated with a service of one merchant indicates a subscription type recurring transaction, which is expected to have an upcoming payment date, and providing the user with one or more options to manage the service. FIGS. 3A and 3B provide a high-level representation of one example for this process and will be described with reference to FIGS. 1 and 2.

According to an illustrative operation of the system of FIG. 2, server(s) 230 such as computing device(s) (e.g., computing device 101) of financial institution 220 may receive a transaction stream 210 from a payment processor in step 300, which provides customer transaction data for incoming charges from merchants to an electronic payment method of a user (customer). It will be appreciated that the terms server and computing device may be used interchangeable herein. The transaction stream 210 may include transaction data for multiple users of electronic payment methods of the financial institution. Alternatively, the server(s) may receive multiple transactions streams, where each stream includes transaction data for one user of an electronic payment method provided by the financial institution. The transaction stream(s) 210 may be received daily.

The transaction data for each individual transaction may be included in the transaction stream 210 at or close to the time of the transaction associated with the incoming charge, or at a time that is not closely proximate to the time of the transaction associated with the incoming charge (e.g., the day after the transaction). Further, the transaction data may be structured in accordance with a data standard used to process payments electronically and/or to exchange electronic transactions using payment cards (e.g., the transaction data may be structured in accordance with the ISO 8583 standard or another standard that is used for financial transaction card messages). The incoming charge may for example comprise an incoming charge for some good and/or services such as an incoming charge for a subscription to an online video streaming service or the purchase of an article of clothing.

The transaction data may comprise a merchant identifier field that indicates the name of the merchant and/or a merchant identifier (e.g., a numeric code) that may be used to identify the merchant associated with the incoming charge, a merchant category code (MCC), the amount of the charge, the date of the charge, and a transaction description of the charge. Further, the transaction data may comprise an electronic payment method field that may indicate a payment method that was used as part of the transaction. For example, the payment method may comprise a transaction card such as a credit card number, a debit card number, or a virtual card numbers (VCNs), or mobile wallet associated with the financial institution. In some cases, the transaction data may include a recurring transaction field indicating that that the incoming charge is a recurring transaction. Also, the transaction data including the electronic payment method field may comprise a transaction card verification value (CVV) field. According to some aspects, the transaction data may be structured in accordance with the ISO 8583 API. In other aspects, the transaction data may be structured in accordance with any API accepted and processed by one or more computing devices of financial institution 220 by a payment processor.

The incoming charge may indicate a good or service for which a user may receive an incoming charge. The merchant identifier may comprise data that may be used to identify the merchant, and may comprise the merchant's name, a merchant ID number, and/or descriptive text that may comprise merchant-identifying information The CVV may indicate a card verification value that is used to improve security for credit card transactions, the presence of which may indicate that the incoming charge is associated with a credit card transaction. The merchant MCC may indicate the type of goods and/or services the merchant provides. The transaction description may comprise a free form text description of the goods and/or services associated with the incoming transaction. The amount of the incoming charge may indicate a monetary value (e.g., a dollar amount or euro amount) associated with the incoming charge.

Following receipt of each transaction stream, financial institution 220 may process the incoming charges for each corresponding user and then the server 230 may store the transaction data as historical transaction data in user transaction data storage 222 associated with the financial institution in step 305. User transaction data storage 222 may include cloud storage or local storage accessible by the server(s) 230, and may be distributed on a distributed network of the financial institution, similar to network 103, and on computing devices similar to computing devices 101 and/or 105.

The user transaction data storage 222 may store user transaction data for each user of financial institution 220 and may maintain that data in storage indefinitely or for a preset period of time (e.g., three years). Thus, the user transaction data storage 222 maintains historical transaction data for each user including past transaction details such as identity of the merchant for each past charge, date of past charges, amount of past charges, and transaction description of past charges.

The identity of the merchant may be represented by different identifiers for different transactions. To avoid not being able to assemble an accurate set of historical data, financial institution may maintain a mapping of merchant identifiers to merchant names.

Financial institution 220, for a user, may determine periodically, such as daily or responsive to a charge being received and processed to the user's electronic payment method for a service of a particular merchant, the probability that the historical transaction data, which includes past charges associated with the particular merchant, indicates that the past charges represent a subscription type recurring transaction that is expected to have an upcoming payment date in step 310. Examples of subscription type services for such subscription type recurring transactions may include streaming media subscription services like HBO Max™, food delivery services like HelloFresh™, gym memberships such as Anytime Fitness™, fruit of the month club, mobile phone service, cable service, or any other services or benefits obtained by making a payment according to a regular cadence.

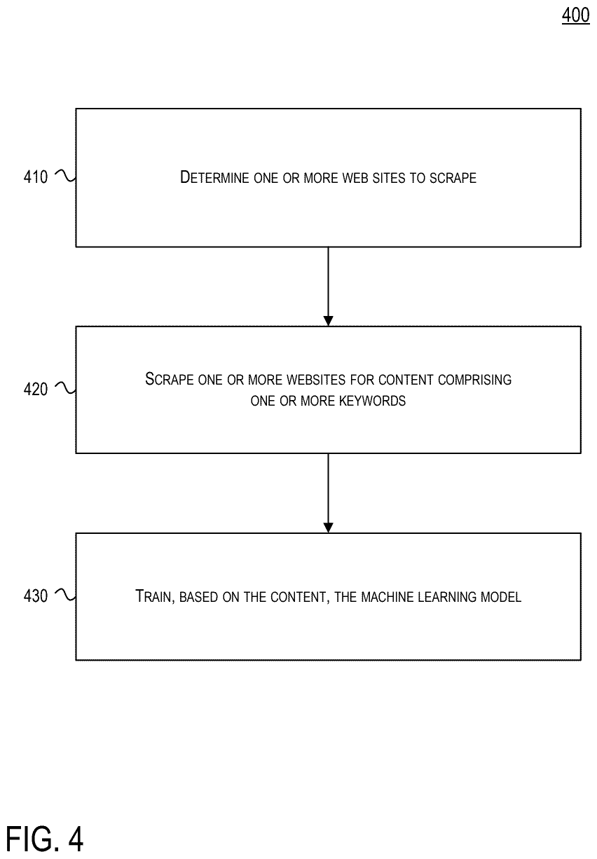

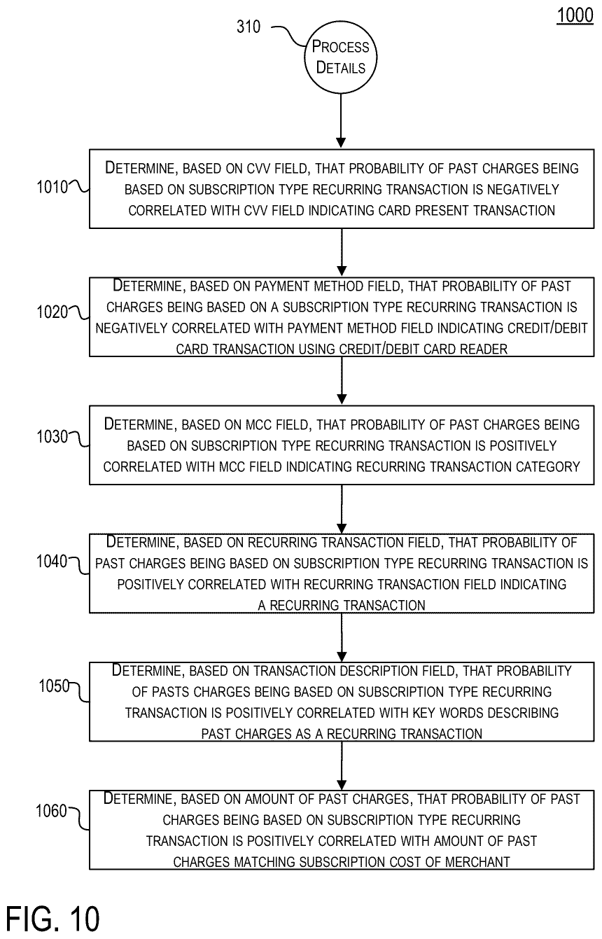

In step 310, the server(s) 230 may determine, based on a machine learning model 225 and the historical transaction data, a probability that historical transaction data of the user for past charges from a particular merchant indicates a subscription type recurring transaction for a service of the particular merchant. FIG. 10, described later herein, provides an example of process details of step 310. Machine learning model 225 may be configured to identify subscription type recurring transactions based on the historical transaction data. For example, machine learning model 225 may receive the user's historical transaction data comprising transaction details for received past charges applied to their electronic payment method. The machine learning model may then perform operations on the received historical transaction data. The operations may comprise determining features of the historical transaction data that may be used to determine a probability that the past transactions associated with the particular merchant included in the historical transaction data indicate a subscription type recurring transaction. The machine learning model may then generate an output comprising a probability that the past charges from the particular merchant for a service indicate a subscription type recurring transaction and a prediction of an expected date of the next (upcoming) transaction. An example of training of the machine learning model is described with respect to FIG. 5.

In step 320, based on the probability (e.g., the probability that the past charges for the particular merchant indicate a subscription type recurring transaction) not exceeding a threshold probability, the past charges for the service of the particular merchant may be identified as past transactions, which do not correspond to a subscription type recurring transaction (e.g., charges from a merchant, which may vary in amount and/or charges which do not occur at a regular cadence). In this case, depending on the relative probability, in step 325 (step 320: yes), a flag, a value, or words may be stored in a recurring transaction field or transaction description field with the historical transaction data for the service of the particular merchant in historical user transaction data store 222. For example, words may be stored in the transaction filed indicating that the historical transaction data is associated with a series of one of food purchases. A flag, for example, may represent that the past charges do not indicate the historical transaction data for the service of the particular merchant is a subscription type recurring transaction. The flag may be applied by machine learning model 225 in the future as a weighting factor (e.g., a negative factor based on the previously determined probability) in the event that machine learning model 225 analyzes again the historical transaction data for the service of the particular merchant such as after more recent historical transaction data for the service of the particular merchant has been stored in historical user transaction data store 222. For example, the probability determined by machine learning model 225 may be compared to the threshold probability and if the probability is less than or equal to the threshold probability then step 330 may be performed.

Based on the probability exceeding a threshold probability (step 320: yes), the server 230 and/or machine learning model 225 based on the regular cadence (e.g., monthly, annually, quarterly) between success past charge dates and/or information from the historical charge data of other users for the service from the same merchant can determine (e.g., predict) the expected upcoming charge date that an expected upcoming charge for the service of the merchant will be processed and store the upcoming transaction data including the expected upcoming charge data in upcoming transaction data memory 224 in step 330. In the case that the probability exceeds the threshold indicating that the historical transaction data for the service of the particular merchant corresponds to a subscription type recurring transaction, a flag, a value or words may be stored in a recurring transaction field or transaction description field with the historical transaction data for the service of the particular merchant in historical user transaction data store 222. The information stored store may indicate that the transaction is a subscription type recurring transaction (e.g., the description in the transaction field may indicate that the historical transaction data is associated with a subscription to a gaming service).

The server 230 may receive user feedback with respect to an accuracy with which the machine learning model identifies subscription type recurring transactions. Further, as part of the process of receiving user feedback a request for user feedback may be sent, via the mobile app to a user and the request for user feedback may comprise questions regarding the accuracy with which the machine learning model identified expected upcoming transactions including the merchant, expected amount and expected payment date. The user may then provide feedback responding in the mobile app, which may forward the feedback to server 230. Server 230 may adjust the threshold probability based on the user feedback. For example, if the user feedback indicates that an expected upcoming transaction was inaccurately determined to be a subscription type recurring transaction, the computing device may increase the threshold probability. As such, the machine learning model will have to determine a greater probability that historical transaction data corresponds to a subscription type recurring transaction before identifying an expected upcoming transaction based on the historical transaction data.

In step 335, server 230 may send, to a service provider API 242 of third party intermediary 240, a query asking what subscription management options are available for the service of the merchant corresponding to the upcoming transaction charge. The query may include a merchant identifier and a service identifier. Third party intermediary 240 may determine whether there are any subscription management options available for the service of the merchant corresponding to the upcoming charge. If the merchant identifier corresponds to an identifier of a merchant which third party intermediary 340 supports, for example Merchant A 255, Merchant B 265, or Merchant C 275, then it may be determined whether the third party intermediary supports one or more subscription management options corresponding to the service represented by the service identifier. If third party intermediary 240 supports one or more subscription management options, the third party intermediary may send a notice of the available subscription management options to server 230. Subscription management options that may be provided include options to allow a user to cancel subscriptions and recurring payments, change (e.g., upgrade or downgrade) subscription plans, pause and resume subscriptions, update payment methods for subscriptions, and receive real-time offers at time of cancellations, and offers to resubscribe after cancellation.

If third party intermediary 240 does not support subscription management options for the service of the merchant corresponding to the upcoming transaction charge (step 335: no), then the third party intermediary may send a message to server 230 that subscription management is not supported and the server carries out step 340. In step 340, server 230 may associate a block charges or allow charges option with the upcoming transaction, by adding the block charge option to the upcoming transaction data in upcoming transaction data memory 224. The block charges function may be configured by the financial institution (inhouse management option) to allow a user to block charges for the upcoming transaction when the user cannot, for example, cancel service by communicating with the merchant via third party intermediary 240. The financial institution can allow a user to block charges from a merchant, without notifying the merchant prior to the merchant attempting to obtain payment for an incoming charge as described in co-pending, U.S. patent application Ser. No. 18/086,836 filed Dec. 22, 2022 and co-pending U.S. patent application Ser. No. 18/051,705 filed Nov. 1, 2022, both of which are incorporated by reference herein. An example of the implementation specifics of block charge function is described in these co-pending applications.

Financial institution 200 may maintain an merchant identification eligibility store 223, which may map the merchants and/or merchant/service combinations to whether or not the merchant and/or merchant/service combinations are supported (provide service management options) by third party intermediary 240. Rather than constantly querying third party intermediary 240, server 230 may determine the support status of a merchant or merchant/service combination by referencing the merchant identification eligibility store 223. Periodically, such as weekly or monthly, the server 230 may send to third party intermediary 240 a bulk query regarding the current support status of all the merchants and/or merchant/service combinations which were not previously supported. Based on third party intermediary 240 providing a status update, the server 230 may update the mapping of the merchants and/or merchant/service combinations maintained in the merchant identification eligibility store 223.

After adding the block charge option to the upcoming transaction data in step 340, server 230 may send upcoming transaction data to financial institution mobile app on user mobile device 202 in step 350. Mobile device 202 may be similar to device 108 in FIG. 1 and may have similar or different architecture as described with respect to computing device 101. The upcoming transaction data may include expected upcoming charge date, expected upcoming charge amount, identity of the merchant, expected transaction description of expected upcoming charge, and the block charges option available to the user to manage the subscription type service.

If third party intermediary 240 supports subscription management options for the service of the merchant corresponding to the upcoming transaction charge (step 335: yes), then server 230 may receive a message from the third party intermediary identifying the supported subscription management options in step 345. Further, server 230 adds the available subscription management options from the third party intermediary to the upcoming transaction data in upcoming transaction data memory 224.

After adding the available subscription management option to the upcoming transaction data in step 340, server 230 sends upcoming transaction data to a financial institution mobile app on user mobile device 202 in step 350. In this case, the upcoming transaction data may include expected upcoming charge date, expected upcoming charge amount, identity of the merchant, expected transaction description of upcoming charge, regular cadence of the charge, and the subscription management options available to the user to manage the subscription type service.

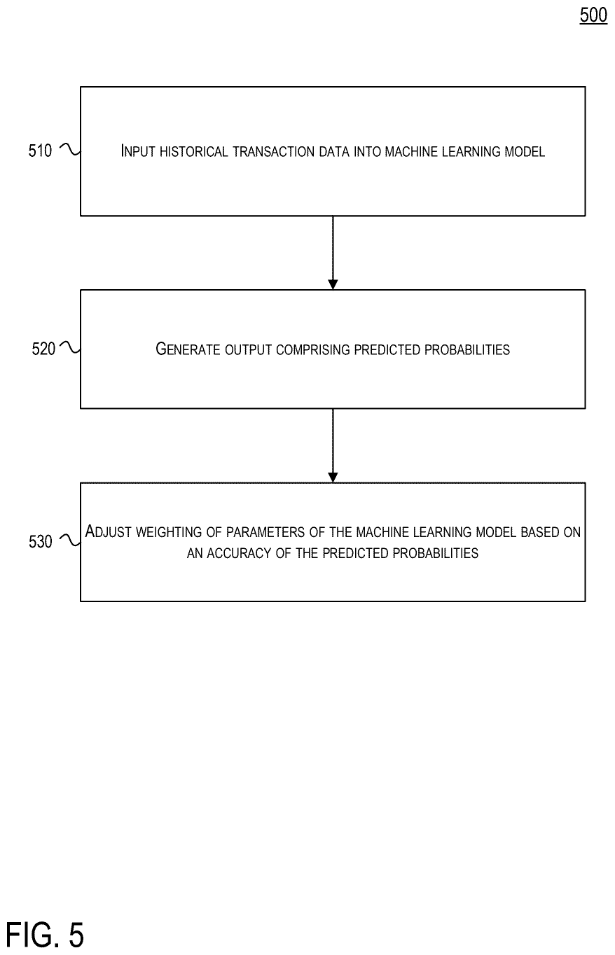

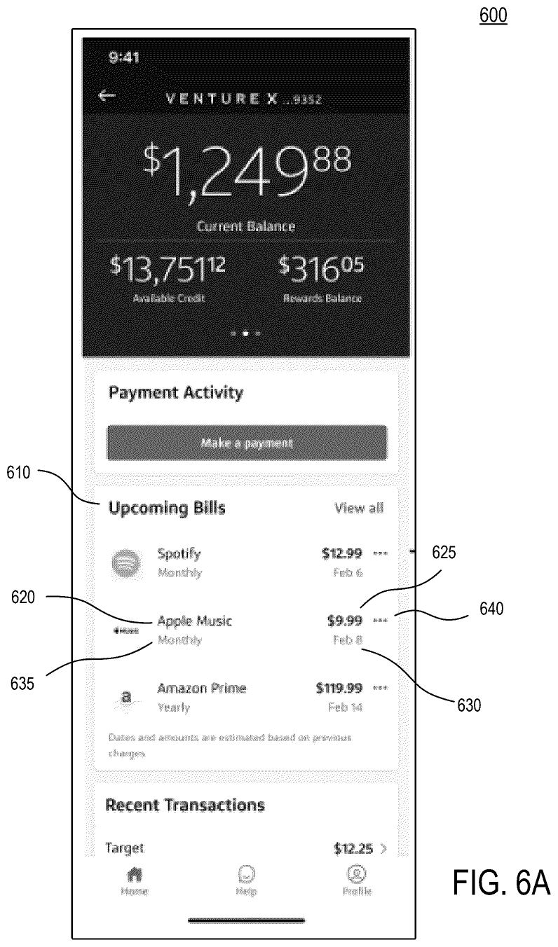

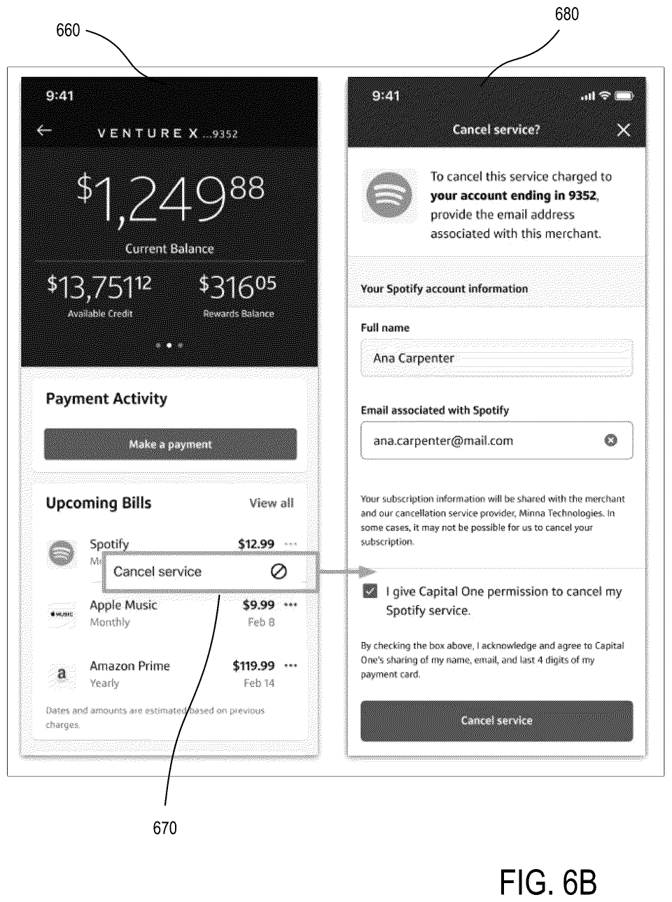

Following step 350 (taking either pathway from step 335), in step 355 when the user 201 accesses their account associated with their electronic payment method (e.g., credit account) on the financial mobile app on mobile device 202, the mobile app may display upcoming transactions, which are subscription type and any available options for managing the subscriptions. An illustrative user interface screen 600 in the mobile app displaying the upcoming transactions for a credit card is shown in FIG. 6A.

On screen 600, upcoming transactions (recurring transactions) as may be identified as upcoming bills 610 may be listed separately from recent transactions for the user to view. In this example, three upcoming transactions are listed with their corresponding upcoming transaction data. For the second upcoming bill listed, the merchant name 610, expected upcoming charge amount 625, expected upcoming charge date 630, and recurring charge period (regular cadence) 635 may be displayed on screen 600. The upcoming bills listed may be presented to include the next three expected upcoming charges, or one, all or less than all of the expected upcoming charges, which may be limited based on the available screen real estate. Also, on the display next to the expected upcoming charge amount 625 may be three dots ( . . . ) as shown on screen 600. By user selection of three dots region 640, via a user input (e.g., tap, point and click, voice or other known input method) to mobile device 202, a menu may appear providing a list of one more options for managing the subscription.

As shown illustrated in FIG. 6B, screen 660 may appear in response to the user input and provide an option 670 which the user may select. In step 360, the mobile app determines (e.g., detects) whether the user 202 has selected the option. If the user does not select any option (step 360: no), it may be that they have exited the display screen displaying the option in step 362.

If the user selects the option in step 360, in step 365 the mobile app, alone or via communication with server 240, may determine if the selected option is a subscription management option available from third party intermediary 240. For example, the upcoming transaction data may include a field to indicate to the mobile app whether the subscription management options are from the third party intermediary or correspond to in house options provided by the financial institution (e.g., block charges).

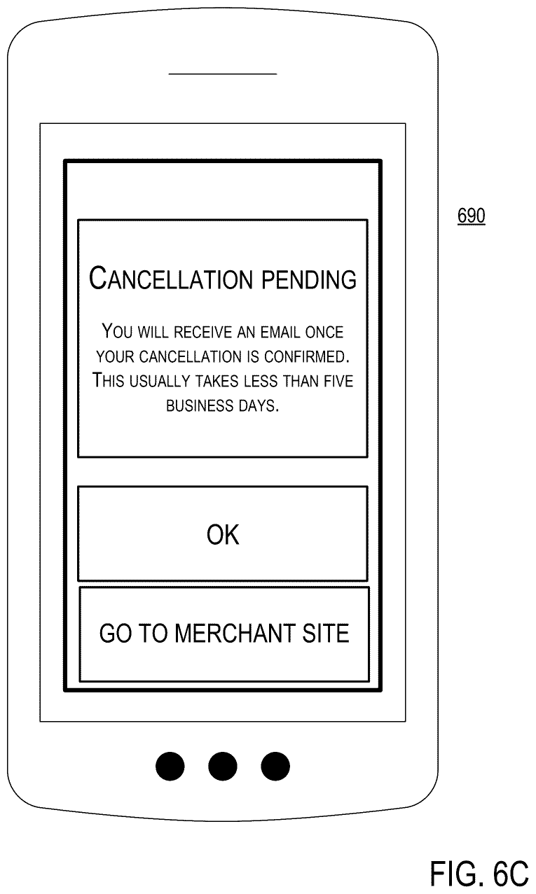

If the selected option does not correspond to a subscription management option available from the third party intermediary (step 365: no), the selected subscription may correspond to the financial institution block charges management option. In this case, in step 366, the mobile app may display a confirmation screen to the user, such as the screen 700 shown in FIG. 7, requesting the user to confirm that they would like to block future charges. If the user does not confirm they wish to block charges then control may return to step 355 or the user may exit the mobile app. If the user confirms they wish to block charges from the particular merchant for the service (step 366: yes), then in step 368 the mobile app may send an instruction to server 230 to block charges for the merchant associated with the upcoming transaction. As discussed, one or more example implementations of the block charges function is described in co-pending, U.S. patent application Ser. No. 18/086,836 filed Dec. 22, 2022 and co-pending U.S. patent application Ser. No. 18/051,705 filed Nov. 1, 2022, both of which are incorporated by reference herein.

If the selected option corresponds to a subscription management option available from the third party intermediary such as by the user selecting the “cancel service” option 670 on screen 660 in FIG. 6B, the mobile app may display a confirmation screen in step 369 similar to screen 700 shown in FIG. 7, but for a service option alter instruction such as pause or cancel, requesting the user to confirm that they would like to block future charges. If the user does not confirm they wish to confirm the service management alter instruction (step 369: no), then control may return to step 355 or the user may exit the mobile app.

In the event, the user selects to continue with the alter instruction in step 369, then the alert instruction may be sent to server 230, which in turns may continue with the optional steps 375, 380 and 385 as shown in dotted box 370 or may skip steps 375, 380 and 385 in dotted box 370, and send the instruction to third party intermediary 240 in step 390. Some alter instructions may have further information to be input by the user before the instruction is sent to third party intermediary 240.

For example, a user may need to provide authorization for the financial institution to act on behalf of the user to send an instruction to cancel a service. In the example, in FIG. 6B, based on the user selecting the “cancel service” option, a form may be provided to the user as illustrated on screen 680. The form may request user 201 to enter their name, email associated with their service account with the merchant and an authorization for financial institution 200 to cancel the service as requested by the user. Upon submission of the form confirming user cancellation of the service and providing financial institution authorization, the mobile app sends the form to server 230, which stores the authorization form in customer consent memory 226. Also, responsive to submission of the form, a cancellation pending screen may be displayed to the user. An example cancellation pending screen may be similar to screen 690 shown in FIG. 6C, and may advise the user that they will be notified of the result of the cancellation in several days by email.

Upon receiving a cancel instruction or pause instruction in step 360, server 230 may store user the corresponding cancellation data or pause in user cancellation and pause data store 228. The user cancellation data may include user identity information, the date of cancellation, user's electronic payment method, and at least some of the upcoming transaction data such as the merchant identity and the identity of the service requested to be cancelled. The user pause data may include user identity information, the date of pause, user's electronic payment method, and at least some of the upcoming transaction data such as the merchant identity and the identity of the service requested to be paused.

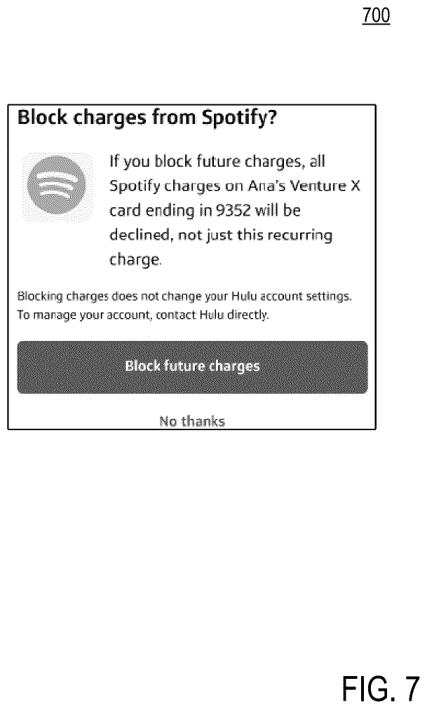

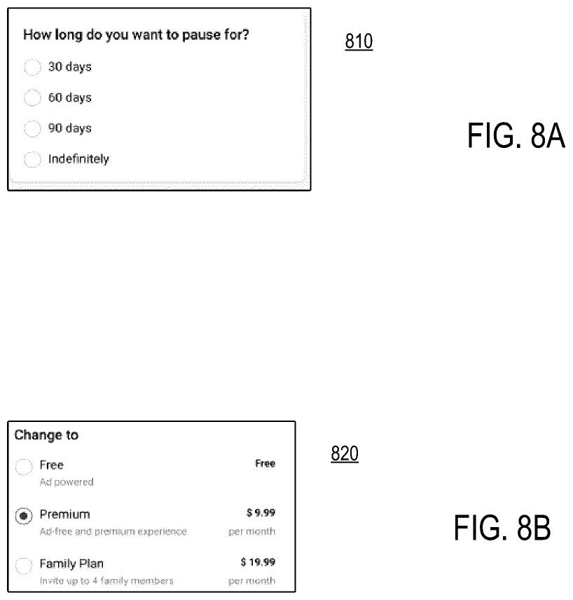

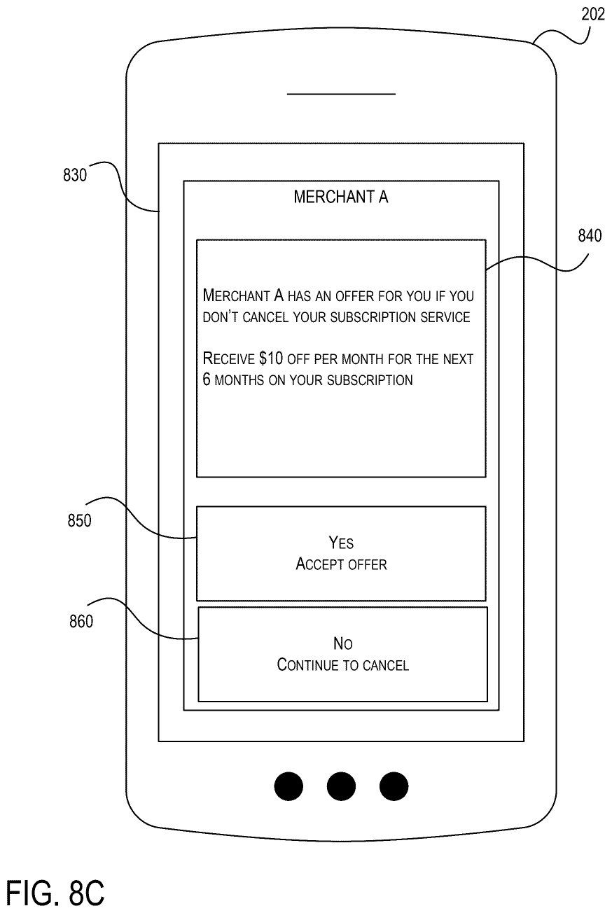

In an example, in which user 201 selects to pause service in step 360, which is a service management option of the third party intermediary, prior to confirming the pause instruction in step 369, the mobile app may display screen 810, as shown in FIG. 8A, prompting user 201 to select the duration of the pause of service. Based on user selection of the pause duration, the process may continue with confirmation being carried out in step 369.

In an example, in which user 201 selects to change service in step 360, which is a service management option of the third party intermediary, prior to confirming the change instruction in step 369, the mobile app may display screen 810 prompting user 201 to update their service plan by selecting one of the available plans. Based on user selection of the service plan, the process may continue with confirmation being carried out in step 369.

In an example, in which user 201 selects to update their payment method in step 360, which is a service management option of the third party intermediary, prior to confirming the updated payment method instruction in step 369, the mobile app may display a screen 820, as shown in FIG. 8B, prompting user 201 to provide, for example, updated account information (e.g., virtual card number, credit card number, card expiration date, security code). Based on the user updating their electronic payment method, the process may continue with confirmation being carried out in step 369.

In certain aspects such as when the alter instruction corresponds to a cancel service instruction or pause service instruction, after receiving confirmation of the alter instruction in step 369, the mobile app may present the user with an offer in their mobile app to continue their service or provide options for updating their service on the display of mobile device 202 in step 375. An example of an offer a user could receive is shown on screen 830 of mobile device 202 in FIG. 8C. In this example, offer 840 provides the user a $10 monthly discount for the next six months to maintain their service. The user may accept the offer by selecting region 850 on screen 830 or decline the offer and continue to cancel (or pause) service by selecting region 860 on screen 830. In step 380, the mobile app determines whether the user accepted or declined the offer.

In another example, after receiving confirmation of the alter instruction in step 369, the mobile app may present the user with a service update screen similar to screen 820 in FIG. 8B along with selection regions similar to 850 and 860, but tailored for a user updating their service type. As in the offer example, the user may select an option to update their service plan by selecting a service option and selecting an accept update region or decline to change/update their service plan and continue to cancel (or pause) service by selecting a decline region on the user interface of the mobile app. In step 380, the mobile app determines whether the user decided to update/change their service plan or continue with canceling or pausing service.

If the user has selected to accept the promotional offer or update their service plan in step 380, the mobile app sends an updated alter instruction corresponding to the accepted promotional offer or updated service plan to server 230. Server 230 may send the updated alter instruction, via third party intermediary APIs including service management functions API 244. Third party intermediary 240 then sends the updated alter instruction to the appropriate merchant, such as merchant A 255, merchant B 265, or merchant C 275 in step 385.

If the user has selected to decline the promotional offer or not update their service plan in step 380, the mobile app sends the original alter instruction (e.g., cancel service, pause service) to server 230 as part of step 390. Server 230 may send the original alter instruction to third party intermediary 240, via third party intermediary APIs including service management functions API 244 as further part of step 390.

For a cancel instruction, an authorization form may be sent by server 230 of financial institution 200, via the letter of attorney API 246, to third party intermediary 240 along with the cancel instruction being sent to service management functions API 244. Third party intermediary 240 may then send the original alter instruction to the appropriate merchant, such as merchant A 255, merchant B 265, or merchant C 275 in step 385. After receiving a cancel instruction, server 230 may store user cancellation data in user cancellation and pause data store 228.

The user cancellation data may include user identity information, the date of cancellation, user's electronic payment method, and at least some of the upcoming transaction data such as the merchant identity and the identity of the service requested to be cancelled. It will be appreciated that certain subscription for services may not be cancelable until a contract for the service, which may not correspond to the regular cadence of payments, has expired. In this instance, the cancel option may not be identified as an available service management option by the third party intermediary, or the option may be identified as available when in truth it can actually only be carried out when a user is not under a contract. In a case where third party intermediary 240 communicates the cancel instruction to the relevant merchant, the merchant may respond to the third party intermediary with a message that the service may not be cancellable or is only cancellable by payment of early termination fee, or has been successfully executed. That information can be sent by third party intermediary to financial institution 200. Referencing the user cancellation data in user cancellation and pause data store 228, server 230 can send a notification to the user regarding status of their cancel request. Notification may be sent to any or all of the user's mobile app, email address on file, or mobile phone via text.

Steps 375, 380, and 385 may not be employed and skipped or only employed for certain management functions such as cancel service or pause service. For example, in a case where a user has selected to update their subscription and has not does so based on being presented with any promotional offer or with a subscription update option after selecting another subscription management option (e.g., cancel or pause), third party intermediary 240 may send, immediately after confirming the alter instruction in step 369, the alter instruction to third party intermediary 240, via third party intermediary APIs including service management functions API 244. Third party intermediary 240 then sends the original alter instruction to the appropriate merchant, such as merchant A 255, merchant B 265, or merchant C 275. In this case, step 390 may immediately follow receiving user confirmation of the alter instruction in step 369. This sequence may also occur where the user has selected the update electronic payment method service management option and updated their electronic payment method prior to confirming, in step 369, the update electronic payment method alter instruction.

Financial institution 220 may provide the ability to unblock (allow) blocked charges when blocked via internal block charge function. Also, third party intermediary may provide service management options including restart a paused service and resubscribe to a canceled service. Financial institution may maintain records of paused services and canceled services in user cancellation and pause data store 228, and may maintain records of blocked services in a blocked services store or in user cancellation and pause data store 228. The financial institution may maintain an inactive (e.g., paused, canceled, blocked) service list with the merchant identifier and user information in user cancellation and pause data store 228 and update that list each time a new service becomes inactive or a previously inactive service is reactivated. The list may be forwarded by server 230 to the user's mobile app for display to user 201 on the screen of mobile device 202.

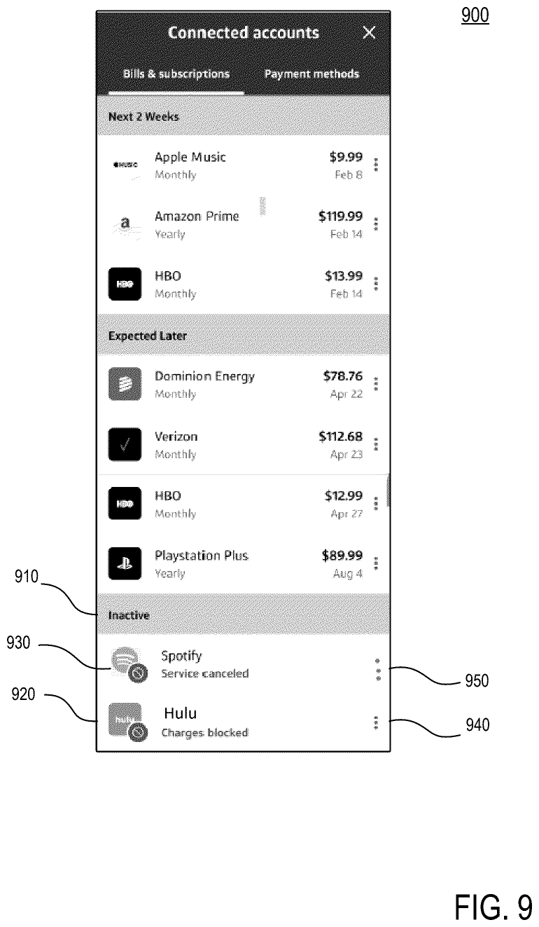

An example screen may include a list of upcoming transactions and a list of inactive subscription services such as illustrated in FIG. 9. On screen 900, inactive list 910 is shown with a service 920 for which charges are blocked and a service 930 which has been canceled. By selecting three dots region 930 next to blocked service 920, the user may be presented with a subscription management option to “allow charges”. In this case, the mobile app, following user confirmation of the allow charges instruction, sends the allow charges instruction to server 230, which causes further charges from the merchant for the service, which was previously blocked, to be allowed and processed and updates a blocked charges data store or user cancellation and pause data store 228. By selecting three dots region 950 next to canceled service 930, the user may be presented with a subscription management option to “resubscribe to service”. In this case, the mobile app, following user confirmation of the resubscribe instruction, sends the resubscribe instruction to server 230, which then sends the resubscribe instruction send to third party intermediary 240, via third party intermediary APIs including service management functions API 244. Third party intermediary 240 then sends the resubscribe instruction to the appropriate merchant, such as merchant A 255, merchant B 265, or merchant C 275. Also, server 230 updates user cancellation and pause data store 228 based on the resubscribe instruction.

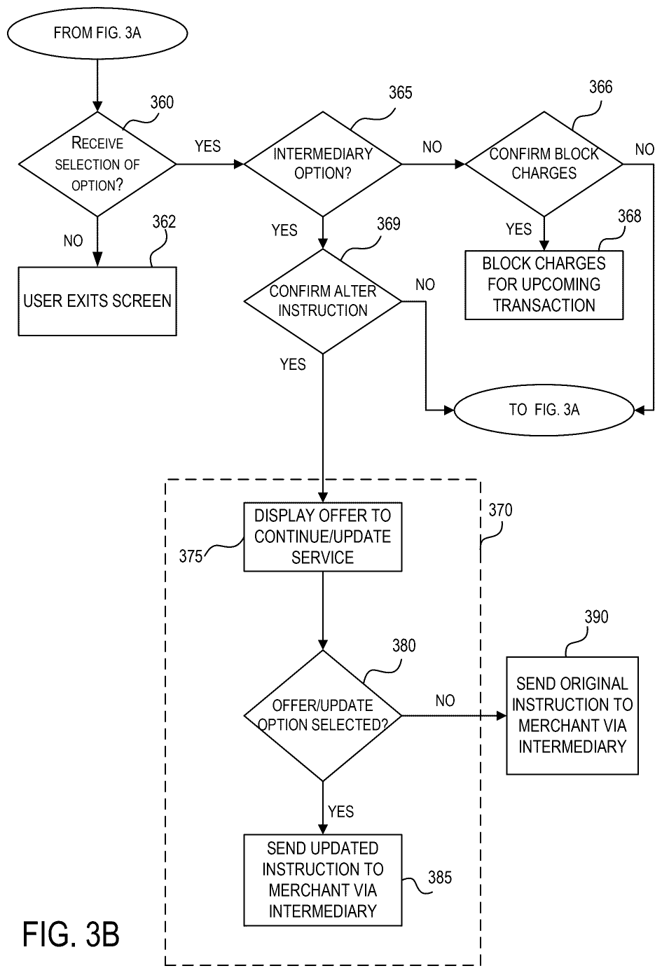

FIG. 4 is an illustrative flowchart of a machine learning model determining a probability that historical charge data of a user associated with a merchant corresponds to a recurring transaction according to aspects of the disclosure.

In step 410, the server 230 may determine one or more websites to scrape based on use of a browser extension that is configured to detect one or more keywords associated with subscription type recurring transactions. For example, after the browser extension detects that a web page of a website associated with a merchant has been accessed, the browser extension may scrape one or more web pages to determine whether web pages of the websites comprise one or more key words associated with a subscription type recurring transaction for the merchant. For example, the browser extension may detect that a user is at a web page associated with a transaction (e.g., a subscription page, a payment page, and/or a service renewal page associated with the merchant). The determination that a user is at a web page associated with a transaction may be based on detection of one or more payment fields within a web page. Based on detecting the one or more payment fields, the browser extension may then search the web page for one or more key words associated with subscription type recurring transactions. For example, the browser extension may search for one or more key words comprising subscription, subscribe, preauthorized, recurring, transaction, renewal, payment, monthly, quarterly, weekly, biweekly, annual, and/or yearly.

By way of further example, after detecting that a user is at a web page associated with a transaction, the browser extension may search the web page for content comprising one or more transaction amounts (e.g., one or more monetary amounts associated with the purchase of goods or services) associated with subscriber type recurring transactions. For example, if the server has determined that the merchant offers subscription services for $14.99 per month, the browser extension may search for a transaction amount of $14.99. When the transaction amount of $14.99 is found, the browser extension may determine whether the transaction amount is in close proximity to (e.g., adjacent to) some indication (e.g., the one or more keywords) that the transaction amount is a subscription recurring transaction. If the transaction amount and/or the one or more key words are associated with subscription recurring transactions, the browser extension may determine that one or more websites associated with the web page will be scraped.

As described herein, a browser extension may be an extension of a browser application that is implemented on a computing device (e.g., the computing devices 101, 107, 108, and/or 109) in order to access websites via a network (e.g., the network 103 illustrated in FIG. 1). In some aspects, the browser extension may be part of a standalone application that may be used to browse websites associated with a particular merchant or a set of merchants.

In step 420, a computing device may scrape one or more websites associated with a merchant for content comprising one or more key words associated with preauthorized recurring transactions. As part of scraping the one or more websites the computing device may access a website associated with a merchant (e.g., a website at which goods or services or a merchant may be purchased), the computing device may search web pages of the website for one or more key words associated with subscriber type recurring transactions. For example, the browser extension may search for one or more key words comprising subscription, subscribe, preauthorized, recurring, transaction, renewal, payment, monthly, quarterly, weekly, biweekly, annual, and/or yearly. Scraping the one or more websites for the content may comprise generating statistics that indicate the frequency of the one or more keywords, the frequency of different combinations of the one or more keywords, the location of the one or more keywords within the web pages, and/or the location of the one or more keywords relative to one or more other keywords.

In step 430, the computing device may train machine learning model 225. The machine learning model may be trained based on the content comprising the one or more key words. Training the machine learning model may comprise providing an input comprising the one or more key words to the machine learning model. The machine learning model may comprise parameters (e.g., adjustable weights and fixed biases) and each of the weights of the machine learning model may be adjusted based on the extent to which each of the weights contributes to increasing or decreasing the accuracy of output generated by the machine learning model. Based on use of a loss function, the parameters may be adjusted such that the loss is minimized (e.g., the output of the machine learning model more closely corresponds to ground truth output that represents optimal output). For example, the parameters that contribute to increasing the accuracy of the output of the machine learning model may be increased and the parameters that contribute to decreasing the accuracy of the machine learning model may be decreased.

For example, the machine learning model may receive input comprising key words (combinations of key words may form key phrases) from a web site of a merchant. The ground truth data may comprise sets of key words that are present in the transaction data (e.g., the transaction description field) of incoming charges that are subscription type recurring transactions. The machine learning model may be trained to determine the probability that historical charge data corresponds to a subscription type recurring transaction based on the extent to which the probability that historical charge data represents a subscription type recurring transaction corresponds to whether the historical charge data actually represents a subscription type recurring transaction.

FIG. 5 is an illustrative flowchart of one aspect of the disclosure in which a machine learning model 225 is trained using various training data according to aspects of the disclosure.

In step 510, the server(s) 230 may input historical transaction data retrieved from the data storage 222 into machine learning model 225. The historical transaction data may comprise historical incoming charges for services from a plurality of merchants. For example, the historical transaction data for each individual transaction may comprise a merchant identifier, A merchant category code, a date on which the transaction was posted, the amount charged to the electronic payment method, and a transaction description. By evaluating consecutive transaction dates with charges of the same amount from the merchant, machine learning model 225 may evaluate the duration between consecutive charges and determine if the historical transaction data indicates a recurring transaction for a service at a regular cadence (e.g., monthly, bimonthly, weekly, biweekly, quarterly, annually, semi-annually, every 30 days, every 60 days, every 90 days). Also, the merchant category code may be evaluated to determine if the types of goods or services associated with the transaction may represent a subscription type recurring transaction. Further, machine learning model 225 may evaluate a description field of the past transactions to determine if the past charges may be associated with ground truth labels indicating whether each of the past transactions is a subscription type recurring transaction rather than an instance in which a user has, for example, made a purchase on the same day for several consecutive weeks. The ground truth labels may comprise sets of key words that may be present in the description field and indicate whether each of the past charges is a subscription type recurring transaction at a regular cadence. As a result, when a predicted probability of a series of past transactions (historical transaction data) is generated representing whether a subscription type recurring transaction with a regular cadence, the ground truth labels may be used to determine the accuracy of machine learning model 225 with respect to the predicted probabilities that were generated.

Further, machine learning model 225 may compare the merchant identifier, past charge amounts, merchant category code, transaction description and the regular cadence with the historical transaction data of other users for similarities. As a result, when a predicted probability of a series of past transactions is a subscription type recurring transaction with a regular cadence, the historical transaction data of other users may be used to increase the accuracy of machine learning model 225 with respect to the predicted probabilities that were generated.

In step 520, the server 230 may generate, based on machine learning model 225 and the historical transaction data, output comprising predicted probabilities that the past charges from the merchant are subscription type recurring transactions. For example, machine learning model 225 may analyze one or more aspects of the historical transaction data based in part on the configuration of parameters of the machine learning model. Machine learning model 225 may then generate predicted probabilities comprising probabilities that each of the past charges at a regular cadence from a particular merchant is a subscription type recurring transaction.

In step 530, server(s) 230 may adjust a weighting of parameters of machine learning model 225 based on an accuracy of the predicted probabilities. For example, the weighting of parameters that are determined to make a greater contribution to accurately predicting whether past charges correspond to a subscription type recurring transaction may be increased. The weighting of the parameters, in certain instances, may be adjusted based on number of past charges at the regular cadence. Further, the weighting of parameters that are determined to make a lesser contribution (or no contribution) to accurately predict whether past charges is a subscription type recurring transaction may be decreased. Machine learning model 225 may be iteratively trained until the accuracy of the predicted probabilities is sufficiently high.

FIG. 10 is an illustrative flowchart of a machine learning model determining a probability that a user's historical transaction data including past charges for the particular merchant indicate a subscription type recurring transaction according to aspects of the disclosure. More specifically, FIG. 10 provides an example of the process details of step 310 from FIG. 3A.

In step 1010, the machine learning model (e.g., a machine learning model similar to the machine learning model 127 in FIG. 1) may determine, based on the value of a CVV field being present in one or more of the past transactions of the historical transaction data from the merchant, that the probability of the past probability being based on a subscription type recurring transaction is negatively correlated with the CVV field indicating that one or more past charges were based on a card present transaction (e.g., a past charge for a card present is less likely to be a subscription type recurring transaction). For example, the machine learning model may receive historical transaction data indicating that the CVV value of a CVV field for a past charge indicates a card present transaction in which a physical credit card was used to perform the transaction associated with the past charge(s). Based on the value indicated in the CVV value and the greater likelihood that card present transactions are more likely to be for one-time purchases, the machine learning model may reduce the generated probability the historical transaction data including the past transactions represent a subscription type recurring transaction.

In step 1020, the machine learning model may determine, based on a payment method field being present in one or more of the past transactions of the historical transaction data, that the probability of the past charges being based on subscription type recurring transaction is negatively correlated with the payment method field indicating that one or more of the past charges is based on a credit/debit card transaction using a card reader device or a mobile wallet transaction using a mobile device and a contactless point of sale system. For example, the machine learning model may receive transaction data indicating that the payment method for a past charge indicates the use of a prepaid account associated with a restaurant chain (e.g., a prepaid gift card) or prepaid card to perform the transaction associated with the past charge(s). Based on the payment method being a prepaid account or prepaid card, and thereby more likely to be a one-time purchase, the machine learning model may reduce the probability of the past charges being a subscription type recurring transaction.

In step 1030, the machine learning model may determine, based on a merchant category code field being present in one or more of the past transactions of the historical transaction data, that the probability of the past charges being based on a subscription type recurring transaction is positively correlated with the merchant category code (e.g., a four digit code indicating the type of good or service provided by a merchant) field indicating that a category of goods or services provided by the merchant correspond to a subscription type recurring transaction. For example, the machine learning model may receive transaction data indicating that the merchant category code associated with the past charges indicates that the merchant is part of a chain of fitness centers which increases the likelihood that the past charge are for the type of good or service that is more likely to be a subscription type recurring transaction. Based on the merchant category code indicating that the merchant is part of a chain of fitness centers, the machine learning model may increase the probability of the past charges corresponding to a subscription type recurring transaction.

In step 1040, the machine learning model may determine, based on a recurring transaction field being present in one or more of the past transactions of the historical transaction data, that the probability of the past charges being based on subscription type recurring transaction is positively correlated with the recurring transaction field indicating that the past charges correspond to a recurring transaction. For example, the machine learning model may receive transaction data indicating that the recurring transaction value of a recurring transaction field for past charges indicates that the past charges correspond to a recurring transaction. Based on the recurring transaction field indicating a recurring transaction, the machine learning model may increase the probability of the past charges corresponding to subscription type recurring transaction.

The recurring transaction field may not be dispositive of a subscription type recurring transaction. Further, the value in the recurring transaction field may have been erroneously entered and other portions of the transaction data may contraindicate the value in the recurring transaction field. For example, if the recurring transaction field indicates that a past charge was for a recurring transaction, other portions of the transaction data such as a transaction description field indicating that the incoming charge is for the purchase of a theater ticket on a particular day may reduce the probability that the incoming charge is a subscription type recurring transaction.

In step 1050, the machine learning model may determine, based on a transaction description field of the transaction data, that the probability of the past charges corresponding to a subscription type recurring transaction is positively correlated with one or more key words describing the past charges as a subscription type recurring transaction. For example, the machine learning model may receive historical transaction data in which the transaction description field indicates that the one or more past charge is for a “MONTHLY MAGAZINE SUBSCRIPTION PAYMENT” which includes the key words “monthly” and “subscription” which are associated with a subscription type recurring transaction. Based on the one or more key words comprising “monthly” and “subscription” the machine learning model may increase the probability of the past charges corresponding to a subscription type recurring transaction.

In step 1060, the machine learning model may determine that the probability of the past charges corresponding to a subscription type recurring transaction is positively correlated with an amount of the past transaction charges matching a subscription cost of the merchant. For example, the machine learning model may receive transaction data indicating that the amount (e.g., the monetary amount) of each past charge is “$12.99” which exactly matches the price of a subscription to a gaming service of the merchant. Based on the amount of the past charges matching the subscription cost of the merchant, the machine learning model may increase the probability of the past charges corresponding to a recurring transaction. It will be appreciated that a change in subscription cost may be detected as well based on information obtained by the financial institution from, for example, the merchant's website or correlated with past transactions of other users showing a subscription price change during the same period represented in the user's past transactions.

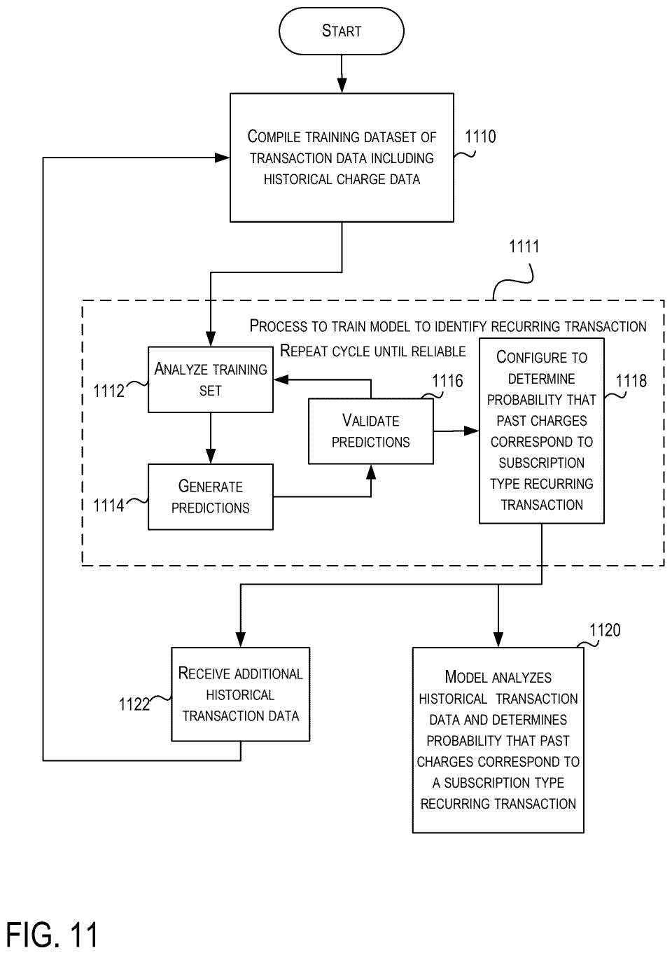

FIG. 11 is an illustrative flowchart representation of a process for training a transaction identification model according to aspects of the disclosure.

The training dataset may be compiled in step 1110. The training dataset, may be similar to the training dataset 129 depicted in FIG. 1, and may be based on historical transaction data from a plurality of merchants and/or users (e.g., users of goods and/or services of the merchants). Further, the training dataset may comprise data obtained from other sources including third-party data providers, analytics providers, merchant-provided information indicating the way in which past charges from those merchants may be structured.

In step 1112, a transaction identification model (e.g., a machine learning model similar to the machine learning model 127 described in FIG. 1) may analyze the training dataset. Based on the analysis of the training dataset, the transaction identification model may generate predicted probabilities that past charges correspond to subscription type recurring transactions in step 1114.

In step 1116, the predicted probabilities generated in step 1114 may be validated against ground truth output that indicates which sets of past charges within the training dataset in step 1116 correspond to subscription type recurring transactions and which sets of the past charges are do not correspond to subscription type recurring transactions. The transaction identification model may then use the validations to improve the performance of the transaction identification model by iteratively cycling through the steps of analysis, prediction, and validation until the transaction identification model is configured and/or trained to accurately determine the probability that a set of past charges corresponds to a subscription type transaction identification in step 1118. Steps 1112, 1114, 1116, and 1118 together provide an example of a process 1111 to train the machine learning model to identify recurring transactions and to repeat the cycle in 1112, 1114, and 1116 until the machine learning model becomes reliable.

After being configured for use, in step 1118, the transaction identification model may analyze historical transaction data and determine the probability that a set of past charges corresponds to a subscription type recurring transaction in step 1120. At this point, the transaction identification model may be used as described herein.

Further, after performance of step 1118, the transaction identification model may be updated over time with an additional transaction dataset in step 1122. In step 1122, the transaction identification model may receive new datasets and iterate through the process previously described in steps 1112-1118. The new datasets may comprise additional sets of past charges, merchant identifiers, CVVs, merchant category codes, transaction descriptions, amounts of past charges, and/or other information that may be used to determine the probability that a past charge for a merchant is a subscription type recurring transaction. The training dataset may be obtained from third parties or compiled based on a plurality of transaction data as described in step 1110. After completing training of the transaction identification model in steps 1112-1118 using the additional transaction data from step 1122, the transaction identification model may, in accordance with the embodiments described herein, be used to determine the probability that past charge data of a user corresponds to a subscription type recurring transaction as described in step 1120.

It will be appreciated that some of the above aspects may be applicable to a scenario in which a merchant is not listed on a blocked merchants list or a blocked merchants list is not available for use in the determination of whether the merchant is on the blocked merchants list. In such cases, a method may comprise receiving transaction data comprising transaction details for an incoming charge associated with a merchant. The merchant may be determined to be included in a blocked merchants list and authorization of incoming charges for preauthorized recurring transactions associated with the merchant may be blocked. Further, based on a machine learning model and the transaction data, a probability that the incoming charge for the merchant is a preauthorized recurring transaction may be determined. The machine learning model may be configured to identify preauthorized recurring transactions based on the transaction data. Based on the probability not exceeding a threshold probability, the authorization of the incoming charge may be prevented from being blocked.

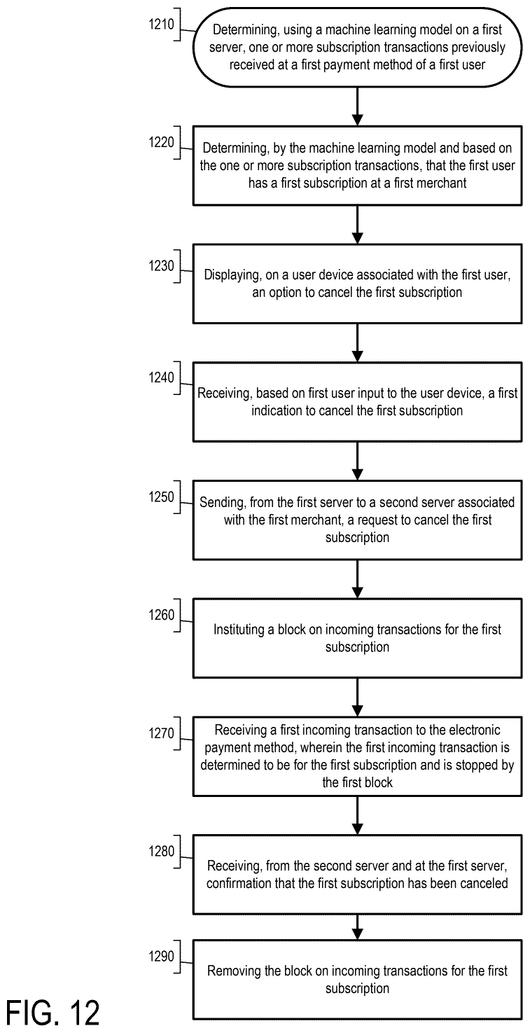

FIG. 12 is an illustrative flowchart of a process for blocking charges to a subscription after sending a cancellation request according to one or more aspects of the disclosure.

A financial institution, which offers electronic payment methods to users, may be interested in providing ways for users to detect and cancel subscriptions. However, incoming transactions to an electronic payment method may not comprise data which clearly indicates the merchant nor what the transaction corresponds to. Financial institutions may also be required, by law and/or by service agreements with merchants and users, to process incoming transactions quickly and accurately. For a financial institution to provide subscription cancellation tools, the financial institution must be able to quickly detect whether a transaction corresponds to a cancelled subscription quickly, without holding up other transactions from processing.

However, blocking charges (e.g., transactions) for a subscription, while allowing non-subscription charges to process may be difficult for a computer to do because transaction data is limited, must be evaluated quickly, and may vary from merchant to merchant. As discussed above with respect to FIG. 2, transactions may be formatted according to a standard data format such as ISO 8583. In this example, because ISO 8583 is widely accepted throughout the industry, it may be very difficult to change types of information which are contained in the transaction data. Additionally, many merchants may not include clear textual indications of a reason for a transaction in transaction data. For example, a majority-subscription service like Spotify may include text “SPOTIFY PREMIUM” in a recurring subscription transaction for Spotify Premium™, which is a service only available as subscription. In another example, Amazon offers both subscription services (such as Amazon Prime™) and non-subscription options (individual items ordered from Amazon). Amazon may not clarify, as text in transaction data, whether a transaction is for Amazon Prime™ or for individual, non-recurring orders.

Additionally or alternatively, a merchant may offer multiple different subscriptions, one or more of which a user may be subscribed to at a time. For example, Amazon offers subscriptions to multiple different TV channels through Amazon Prime™: Paramount+, AMC+, ESPN, etc. A user may wish to cancel a subscription to AMC+, but keep a subscription to ESPN and Amazon Prime™. In this example, transactions for both the AMC+ subscription and the ESPN subscription may be received from Amazon, and a text description in the transaction data may not contain indicators of which transaction corresponds to which subscription.

An additional obstacle is that merchants may modify transaction data for subscription transactions. For example, merchants may be motivated to ensure payment for subscription services, while a financial institution may be motivated to improve user experiences by employing methods described herein to allow a user to block subscription transactions. In this example, a merchant may modify transaction data for the first subscription in an effort to ensure payment: in other words, circumvent the block. Although a merchant and a financial institution may be driven by business reasons-ensuring payment for services made available to the user or provide more user services, respectively-a technical solution is required to determine when updated transaction data may still be associated with an existing subscription. In another example, a merchant may change pricing associated with a subscription, and a financial institution may need to detect such changes to continue blocking transactions for the subscription. For example, a merchant may stop sending transactions with text stating “SUBSCRIPTION” in an effort to circumvent a block. To continue maintaining effective blocks, a financial institution may need to regularly update blocking and detecting mechanisms.

To detect subscription transactions quickly, financial institutions may wish to minimize additional processing steps on incoming transactions. As a result, removing a processing step when said processing step becomes unnecessary may improve overall processing speed, allowing transactions to be evaluated more quickly.

In step 1210, a machine learning model may determine one or more subscription transactions (e.g., subscription type recurring transactions) based on previously received transactions at a first electronic payment method of a first user. The first electronic payment method may be similar to the electronic payment method described with respect to FIG. 2 and FIG. 3 and may be provided by a financial institution to the first user. Previously received transactions at the first electronic payment method may comprise financial transactions received over a period of time (i.e., in the previous month, quarter, year, or other time increment) at the first electronic payment method. The previously received transactions may comprise both subscription transactions and non-subscription transactions. The previously received transactions may also be limited to transactions from a first merchant. In this example, the machine learning model may determine one or more transactions from the first merchant before determining one or more subscription transactions based on the one or more transactions from the first merchant.

The machine learning model may be similar to the machine learning model described with respect to machine learning model 225 in FIG. 2 and trained via a process similar to that described with respect to FIG. 11. The machine learning model may be trained on transactions received at multiple electronic payment methods associated with multiple users. The machine learning model may be (similar to machine learning model 225 in FIG. 2) hosted on a first server. The first server may be one or more computing devices similar to computing devices 101, 105, and/or 107 as described in FIG. 1. The first server may be accessed over a network similar to network 103 in FIG. 1. The first server may be hosted, operated, and/or controlled by a financial institution, which may be the same financial institution which provides the first electronic payment method to the first user as described above.

In step 1220, the machine learning model may determine, based on the one or more subscription transactions identified in step 1210, that the first user has a first subscription at a first merchant. The first subscription at the first merchant may also be referred to as a first account at the first merchant. The first subscription may be an active subscription, wherein the first merchant sends recurring transactions to the first electronic payment method for the first subscription. The machine learning model may further base the determination of the first subscription on one or more aspects associated with the one or more subscription transactions. For example, the machine learning model may be more likely to determine the first subscription based on a number of subscription transactions received at the first payment method, a cadence at which the one or more subscription transactions were received, text data in a subscription transaction indicating a subscription, and/or other data. The machine learning model may also incorporate information from outside the one or more subscription transactions, such as data scraped from merchant websites. The machine learning model may also weight (e.g., further base) the determination based on factors as described with respect to FIG. 10.

In step 1230, the first server may cause display of, on a user device associated with the first user, an option to cancel the first subscription. The user device may be similar to computing devices 101, 107, 108, or 109 as described with respect to FIG. 1. The first server may connect to the user device over a network similar to network 103 as described in FIG. 1.

The first server may cause display of the option to cancel the first subscription via an application (e.g., an app) installed on the user device. The application may be designed or controlled by the financial institution. Display of the option to cancel the first subscription may be similar to the user interface as shown in and described with respect to FIG. 6A-6C. For example, one or more subscriptions, associated with one or more merchants, may be displayed on the user device. In this example, the user may select one or more subscriptions to cancel. In this example, the one or more subscriptions may also be organized according to a next predicted payment (e.g., transaction) date, as further described with respect to FIG. 6A.

In step 1240, the first server may receive, based on first user input to the user device, an indication to cancel the first subscription. The first server may receive the indication via network 103, as described in FIG. 1, from the user device. The first user input may look similar to the user input shown in and described with respect to FIG. 6B. For example, the user may select the first subscription from a list of one or more subscriptions. The user may also input information about the first subscription to be used in step 1250, as further described below. The indication to cancel the first subscription may also be similar to the “cancel instruction” as described with respect to step 360 in FIG. 3B.

In step 1250, the first server may send a request to cancel the first subscription to a second server associated with the first merchant. The second server may be one or more computing devices similar to computing devices 101, 105 and/or 107 as described with respect to FIG. 1. The request may be transmitted from the first server to the second server over a network similar to network 103 as described with respect to FIG. 1. The request to cancel the first subscription may be sent or formatted based on an Application Programming Interface (API). Additionally or alternatively, the request to cancel the first subscription may be sent to an intermediary between the financial institution and the first merchant, similar to the intermediary described in FIG. 3B.

Additionally or alternatively, the first server may receive an option to alter the first subscription from the first merchant or the intermediary. The option to alter the first subscription may be triggered based on the first merchant or the intermediary receiving the request to cancel the first subscription. The first server may cause the option to alter the first subscription to be displayed on the user device. This example is described further with respect to steps 369 and 370 in FIG. 3B, or as shown with respect to FIG. 8C.

In step 1260, the first server may institute a first block configured to stop incoming transactions for the first subscription (e.g., block charges to the first subscription). The first block may prevent transactions for the first subscription from being applied to the first electronic payment method. The first block may be instituted as an additional step, during processing of an incoming transaction, to determine whether the incoming transaction is a subscription transaction associated with the first subscription. The machine learning model may be used to determine whether the incoming transaction is a subscription transaction associated with the first subscription.

The first block may be instituted as a temporary measure while the request to the first merchant, sent in step 1250 above, is pending at the first merchant. For example, it is common for a merchant to require 3-5 business days before enacting an action based on the request. In other words, the first merchant may not cancel the first subscription until 3-5 business days after receiving the first request in step 1250. However, it may also be common for a user, seeing an upcoming date for a next transaction for a subscription (as shown in FIG. 8A), to cancel a subscription shortly before the next transaction is due to be received at the user's electronic payment method. In this scenario, the user may input an indication to cancel the subscription, as discussed in step 1240, but the merchant may send a transaction for the subscription before processing the request to cancel. A block on incoming transactions for the subscription may ensure that the user is not charged for a subscription they indicated is to be canceled.

In step 1270, the first server may receive a first incoming transactions and, based on the first incoming transaction being determined by the machine learning model to be a subscription transaction associated with the first subscription, may block the first incoming transaction from being applied to the electronic payment method. The first server may break the determination process into several steps in order to eliminate transactions which are unlikely to correspond to the first subscription. For example, an incoming transaction may first be evaluated to determine if the transaction is from the first merchant. If the incoming transaction is not from the first merchant, the first server may determine that the incoming transaction is unlikely to correspond to the first subscription, and further evaluations may be bypassed. If the incoming transaction is from the first merchant, the first server may then further evaluate the transaction to determine if it is for the first subscription. If the incoming transaction is not from the first subscription, the financial institution may allow the incoming transaction to process to the electronic payment method. By evaluating for the first merchant and then the first subscription, the financial institution may ensure that the extra processing time is only required for transactions which have a higher chance of being for the first subscription.

Based on stopping (e.g., blocking) the first incoming transaction, the first server may also notify the user that the first incoming transaction was prevented from being applied to the electronic payment method.

In step 1280, the first server may receive confirmation from the second server, on behalf of the first merchant, that the first subscription has been canceled. The first server may receive the confirmation over a network similar to network 103 in FIG. 1. Confirmation from the second server may indicate that the first merchant will no longer send transactions for the first subscription to the electronic payment method of the first user. Additionally or alternatively, in an example where the first user indicated that they wished to pause the first subscription for a duration of time, but not cancel the first subscription, the confirmation may indicate that the first merchant will not send transactions for the first subscription for the duration of time. In another example, wherein an option to alter the first subscription is provided as discussed with respect to FIG. 3B, the confirmation may indicate that the alter option has been implemented by the first merchant. In this example, the confirmation may also be used to update the machine learning model to identify an incoming transaction under the altered subscription. For example, the confirmation may indicate that a price of the first subscription may be changed from 15.99 to 11.99, and the confirmation used to update the machine learning model to further detect that an incoming transaction with a price of 11.99 is associated with the first subscription.

In step 1290, the first server may remove the first block on incoming transactions to the first subscription. Removing the first block may provide for incoming transactions to the electronic payment method to be processed more quickly, ensuring that incoming transactions can be processed within an allotted time. Removing the first block may specifically provide for increased processing speed for incoming transactions from the first merchant because these transactions will no longer need to be evaluated with additional steps (as described with respect to steps 1260 and 1270). In the example where the first subscription is paused, removing the first block provides for incoming transactions for the first subscription to be received and applied to the electronic payment method after the duration of time has ended. In the example where the first subscription is altered, removing the first block may allow for incoming transactions with the alter option implemented (i.e., a reduced price) to be applied to the electronic payment method. In this example, the first block may have ensured that pre-alter incoming transactions, with an original price, are not applied to the electronic payment method. The first server may also update the machine learning model based on the first incoming transaction. Updating the machine learning model based on the first incoming transaction may help ensure that the machine learning model continues to reliably identify subscription transactions for future incoming transactions. For example, the machine learning model may be used to identify subscription transactions for subscriptions of other users with the first merchant. Updating the machine learning model may improve the machine learning model's detection of subscription transactions across multiple users.

Additionally or alternatively, the first server may cause display of an option for the user to reactivate the first subscription. The first server may cause display of this option on the user device in an interface similar to that shown in FIG. 9. If the user indicates, based on third user input, that the user wishes to reactivate the first subscription, the first server may send a request to the second server associated with the first merchant to reactivate the first subscription. Because the first server has already removed the first block, the first server will be able to accept incoming transactions for the first subscription once the first subscription has been reactivated at the first merchant. Additionally or alternatively, if the first block was not removed per step 1290, the first server may check whether the first block is still in place based on the third user input to reactivate the first subscription. If the first block is still in place, the first server may remove the first block.

Additionally or alternatively, in step 1280, the first server may receive an indication from the second server that the first merchant has denied the cancelation and/or the first server may not receive a response from the first merchant. In this example, the first server may continue instituting the first block and may not remove the first block as otherwise described in step 1290. Additionally or alternatively, upon receiving an indication that the first merchant has denied the cancelation request, the first server may remove the first block as described in step 1290. In this example, the first server may also notify the user that the first subscription cannot be canceled and that the first block will be removed. The first server may cause an option to be displayed to the user which provides a link to a website of the first merchant, allowing the user to navigate to the website of the first merchant and request that the first subscription be canceled directly.

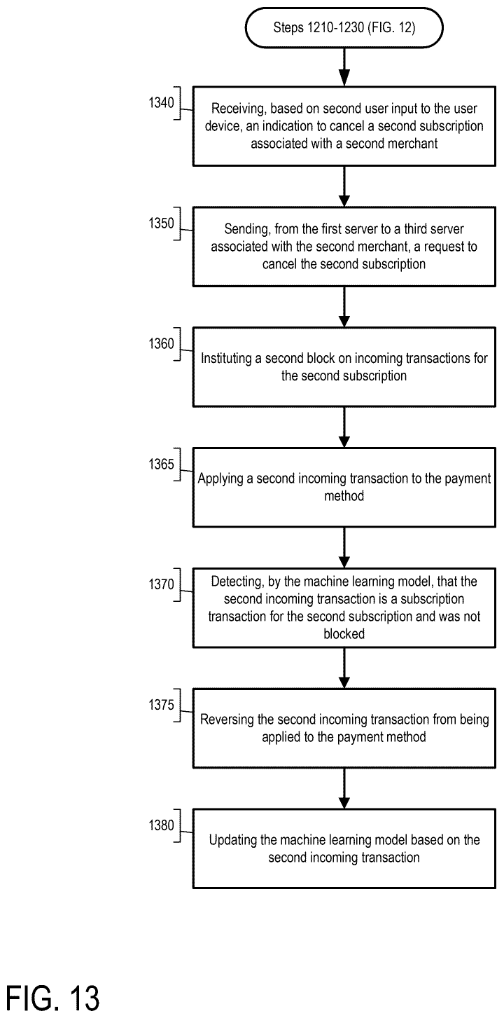

FIG. 13 is an illustrative flowchart of a process for detecting subscription transactions that were not blocked according to one or more aspects of the disclosure. It will be appreciated that the steps described in FIG. 13 may also follow steps 1210-1230 as described in FIG. 12, and may further take place alongside steps 1240-1280 as also described in FIG. 12. It will be further appreciated that while FIG. 13 describes a second subscription for ease of discussion, the steps of FIG. 13 may be applied to the first subscription in FIG. 12 as well.

In step 1340, the first server may receive, based on second user input to the user device, an indication to cancel a second subscription associated with a second merchant. Step 1340 may be similar to step 1240 in FIG. 12, with the first server receiving the second user input, from the user device, over network 103 as described in FIG. 1.

In step 1350, the first sever may send, to a third server associated with the second merchant, a request to cancel the second subscription. Step 1350 may be similar to step 1240 in FIG. 12; for example, the request to cancel the second subscription may be transmitted over network 103 and may be sent and/or formatted based on an API. Additionally or alternatively, as described in step 1250, the request to cancel the second subscription may alternatively be a request to alter or pause the second subscription. The request to cancel the second subscription may also be sent to an intermediary between the first server and the second merchant, similar to the intermediary described in FIG. 3B.

In step 1360, the first server may institute a second block on incoming transactions for the second subscription. The first server may institute the second block by similar methods as described in step 1260 in FIG. 12 for the first block. For example, the second block may be instituted as an additional step during processing of an incoming transaction, wherein the machine learning model may evaluate the incoming transaction to determine if the incoming transaction is a subscription transaction associated with the second subscription.

In step 1365, a second incoming transaction may be applied to the electronic payment method (e.g., a second incoming transaction may not be blocked). The second incoming transaction may be received from the first merchant at the first server over a network similar to network 103 in FIG. 1. The first server may perform one or more processing or analysis steps on the second incoming transaction before the second incoming transaction is applied to the electronic payment method. For example, based on the second block instituted in step 1360, the first server may analyze the second incoming transaction to determine if the second incoming transaction is a subscription transaction associated with the second subscription. The one or more processing (e.g., analysis) steps may be similar to the steps described with respect to step 1270 in FIG. 12, step 310 in FIG. 3, and/or steps 1010-1060 in FIG. 10. The first server may carry any one or more of these steps. For example, the first server may carry out the analyzing steps described with respect to step 1010 (check if card present field indicates an in-person transaction) and step 1050 (check if transaction description field indicates subscription transaction). The first server may also carry out a step to identify a merchant associated with the second incoming transaction, as described with respect to steps 1260 and 1270 in FIG. 12. The first server may carry out any of these steps using the machine learning model.

In step 1370, the machine learning model may determine that the second incoming transaction, applied to the electronic payment method in step 1365, is a subscription transaction corresponding to the second subscription but which was not stopped by the second block instituted (e.g., blocked) in step 1360. For example, the machine learning model may be used by the first server to analyze applied transactions on a scheduled basis to detect if a subscription transaction (e.g., the second incoming transaction) that should have been blocked was applied to the electronic payment method. Additionally or alternatively, the first server may determine that the second incoming transaction is a subscription transaction corresponding to the second subscription based on a third user input from the first user. For example, the first user may recognize that the second incoming transaction should have been blocked (per the second user input in step 1340). The first user may, via third user input, send an indication to the first server that the second incoming transaction is a subscription transaction corresponding to the second subscription and was not blocked. In another example, step 1370 may be triggered based on input from a second user with a subscription also from the second merchant, wherein the machine learning model is used to analyze recent transactions from the second merchant. In other words, based on an indication that a subscription transaction from the second merchant was not blocked despite an instituted block, the first server may trigger the machine learning model to analyze recent transactions from the second merchant across one or more users to determine whether other subscription transactions from the second merchant were erroneously applied to electronic payment methods of the one or more users.

In step 1375, the first server may reverse (e.g., remove) the second incoming transaction from being applied to the electronic payment method. In other words, the first server may retroactively “block” the second incoming transaction by removing it from the electronic payment method. Additionally or alternatively, the first server may apply a credit to the electronic payment method, wherein the credit has a monetary value at least equal to a monetary value of the second incoming transaction, to counteract the effect of the second incoming transaction. The first server may also notify the user, based on the failure of the second block, that the second block failed to identify and block the second incoming transaction. The notification may also comprise an option to remove or update the second block. Removing the second block may be similar to removing the first block in step 1290 in FIG. 12. Updating the second block may be done by updating the machine learning model, as further described below for step 1380. Additionally or alternatively, the first server may remove the second block without waiting for an indication from the user that the second block should be removed. In this example, the first server may remove the second block because the second block is no longer effective and removing the second block improves efficiency when processing incoming transactions.

In step 1380, the machine learning model may be updated (e.g., re-trained) based on the second incoming transaction. The machine learning model may be updated to improve the machine learning model's identification of future transactions as subscription transactions which are associated with the second subscription. The machine learning model may be updated based on methods similar to those described in steps 1110-1122 in FIG. 11. The machine learning model may also be updated based on one or more other incoming transactions, or updated based on the one more other incoming transactions instead of the second incoming transactions. For example, the machine learning model may be updated based on transactions received at electronic payment methods associated with one or more users, which may not include the first user. Additionally or alternatively, steps 1370, 1375, and 1380 may be carried out in any order. For example, the machine learning model may be updated based on the second incoming transaction (as in step 1380), and then the updated machine learning model may then detect that the second incoming transaction is a subscription transaction associated with the second subscription (step 1370). In another example, the first server may receive an indication from the first user, such as via the third input to the user device, that the second incoming transaction is a subscription transaction associated with the second subscription. In this example, the first server may remove or credit the second incoming transaction before updating the machine learning model and confirming that the machine learning model predicts that that second incoming transaction is a subscription transaction corresponding to the second subscription. In this example, the reversal or credit of the second incoming transaction may also be temporary, and may be in turn be removed if the machine learning model determines that the second incoming transaction was correctly applied to the electronic payment method.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. The steps of the methods described herein are described as being performed in a particular order for the purposes of discussion. A person having ordinary skill in the art will understand that the steps of any methods discussed herein may be performed in any order and that any of the steps may be omitted, combined, and/or expanded without deviating from the scope of the present disclosure. Furthermore, the methods described herein may be performed and/or implemented using any manner of device, system, apparatus, and/or non-transitory computer readable media including the computing devices, computing systems, computing apparatuses, and/or non-transitory computer readable media that are described herein.

What is claimed is:

1. A computing method, comprising:
determining, using a machine learning model on a first server trained to predict whether a transaction received at a server and for an electronic payment method is a subscription transaction, one or more subscription transactions previously received at the first server and for a first electronic payment method of a first user;
determining, using the machine learning model and based on the one or more subscription transactions, that the first user has a first subscription at a first merchant, wherein the one or more subscription transactions correspond to one or more payments from the first electronic payment method to the first merchant for the first subscription;
causing display of, by the first server and on a user device associated with the first user, an option to cancel the first subscription:
receiving, based on first user input to the user device and at the first server, an indication to cancel the first subscription;
sending, from the first server to a second server associated with the first merchant, a request to cancel the first subscription;
instituting a first block, wherein the first block is configured to stop incoming transactions for the first subscription, and wherein stopping a first incoming transaction comprises:
receiving, at the first server, the first incoming transaction for the first electronic payment method;
determining, using the machine learning model, whether the first incoming transaction is from the first merchant;
determining, using the machine learning model and based on the one or more subscription transactions corresponding to one or more payments for the first subscription, whether the first incoming transaction is for the first subscription; and
based on the first block and based on determining that the first incoming transaction is for the first subscription, preventing the first incoming transaction from being applied to the first electronic payment method;
receiving, at the first server and from the second server, an indication that the first subscription has been canceled by the first merchant; and
removing the first block.

2. The computing method of claim 1, wherein stopping the first incoming transaction further comprises:
notifying the first user that the first incoming transaction, based on the first block, was prevented from being applied to the first electronic payment method.

3. The computing method of claim 1, further comprising:
receiving, based on second user input to the user device and at the first server, an indication to cancel a second subscription of the one or more subscriptions, wherein the second subscription is associated with a second merchant;
sending, from the first server to a third server associated with the second merchant, a request to cancel the second subscription;
instituting a second block, wherein the second block is configured to stop incoming transactions for the second subscription;
receiving, at the first server and for the first electronic payment method, a second incoming transaction;
applying the second incoming transaction to the first electronic payment method;
detecting, using the machine learning model, that the second incoming transaction is a subscription transaction for the second subscription and was not blocked;
reversing the second incoming transaction from being applied to the first electronic payment method; and
updating, based on the second incoming transaction, the machine learning model.

4. The method of claim 3, further comprising:
notifying, by the first server and on the user device, the first user that the second block failed to block transactions for the second subscription; and
causing display of, by the first server and on the user device, an option to remove the second block.

5. The computing method of claim 1, further comprising:
causing display of, on the user device and by the first server, an option to reactivate the first subscription.

6. The computing method of claim 5, further comprising:
receiving, based on third user input to the user device and on the first server, an indication to reactivate the first subscription; and
sending, from the first server to the second server, a request to reactivate the first subscription.

7. The computing method of claim 1, wherein instituting the first block further comprises:
updating, based on the first incoming transaction, the machine learning model.

8. A non-transitory computer readable medium having instructions stored thereon that, when executed by one or more processors, cause the one or more processors to perform steps comprising:
determining, using a machine learning model on a first server trained to predict whether a transaction received at a server and for an electronic payment method is a subscription transaction, one or more subscription transactions previously received at the first server and for a first electronic payment method of a first user;
determining, using the machine learning model and based on the one or more subscription transactions, that the first user has a first subscription at a first merchant, wherein the one or more subscription transactions correspond to one or more payments from the first electronic payment method to the first merchant for the first subscription;
causing display of, by a first server and on a user device associated with the first user, an option to cancel the first subscription:
receiving, based on first user input to the user device and at the first server, an indication to cancel the first subscription;
sending, from the first server to a second server associated with the first merchant, a request to cancel the first subscription;
instituting a first block on incoming transactions for the first subscription, wherein instituting the first block comprises:
receiving, at the first server, a first incoming transaction for the first electronic payment method;
determining, using the machine learning model, whether the first incoming transaction is from the first merchant;
determining, using the machine learning model and based the one or more subscription transactions corresponding to one or more payments for the first subscription, whether the first incoming transaction is for the first subscription; and
based on the first block and based on determining that the first incoming transaction is for the first subscription, preventing the first incoming transaction from being applied to the electronic payment method;
receiving, at the first server and from the second server, an indication that the first subscription has been canceled by the first merchant; and
removing the first block.

9. The non-transitory computer readable medium of claim 8 having instructions stored that, when executed by the one or more processors, cause the one or more processors to perform steps further comprising:
notifying the first user when the first incoming transaction, based on the first block, is prevented from being applied to the first electronic payment method.

10. The non-transitory computer readable medium of claim 8 having instructions stored that, when executed by the one or more processors, cause the one or more processors to perform steps further comprising:
receiving, based on second user input to the user device and at the first server, an indication to cancel a second subscription of the one or more subscriptions, wherein the second subscription is associated with a second merchant;
sending, from the first server to a third server associated with the second merchant, a request to cancel the second subscription;
instituting a second block, wherein the second block is configured to stop incoming transactions for the second subscription;
receiving, at the first server and for the first electronic payment method, a second incoming transaction;
applying the second incoming transaction to the first electronic payment method;
detecting, using the machine learning model, that second incoming transaction is a subscription transaction for the second subscription and was not blocked;
reversing the second incoming transaction from being applied to the first electronic payment method; and
updating, based on the second incoming transaction, the machine learning model.

11. The non-transitory computer readable medium of claim 10 having instructions stored that, when executed by the one or more processors, cause the one or more processors to perform steps further comprising:
notifying, by the first server and on the user device, the first user that the second block failed to block transactions for the second subscription; and
causing display of, by the first server and on the user device, an option to remove the second block.

12. The non-transitory computer readable medium of claim 8 having instructions stored that, when executed by the one or more processors, cause the one or more processors to perform steps further comprising:
causing display of, on the user device and by the first server, an option to reactivate the first subscription.

13. The non-transitory computer readable medium of claim 12 having instructions stored that, when executed by the one or more processors, cause the one or more processors to perform steps further comprising:
receiving, based on second user input to the user device and on the first server, and indication to reactivate the first subscription; and
sending, from the first server to the second server, a request to reactivate the first subscription.

14. The non-transitory computer readable medium of claim 8, wherein instituting the first block further comprises:
updating, based on the first incoming transaction, the machine learning model.

15. A computing device, comprising:
one or more processors; and
memory storing instructions that, when executed by the one or more processors, cause the computing device to:
determine, using a machine learning model on a first server trained to predict whether a transaction received at a server and for an electronic payment method is a subscription transaction, one or more subscription transactions previously received at the first server and for a first electronic payment method of a first user;
determine, using the machine learning model and based on the one or more subscription transactions, that the first user has a first subscription at a first merchant, wherein the one or more subscription transactions correspond to one or more payments from the first electronic payment method to the first merchant for the first subscription;
cause display of, by a first server and on a user device associated with the first user, an option to cancel the first subscription:
receive, based on first user input to the user device and at the first server, an indication to cancel the first subscription;
send, from the first server to a second server associated with the first merchant, a request to cancel the first subscription;
institute a first block on incoming transactions for the first subscription, wherein instituting the first block comprises:
receiving, at the first server, a first incoming transaction for the first electronic payment method;
determining, using the machine learning model, whether the first incoming transaction is from the first merchant;
determining, using the machine learning model and based on the one or subscription transactions corresponding to one or more payments for the first subscription, whether the first incoming transaction is for the first subscription; and
based on the first block and based on determining that the first incoming transaction is for the first subscription, prevent the incoming transaction from being applied to the electronic payment method;
receive, at the first server and from the second server, an indication that the first subscription has been canceled by the first merchant; and
remove the first block.

16. The computing device of claim 15, wherein the memory storing instructions that, when executed by the one or more processors, further cause the computing device to:
notify the first user when the first incoming transaction, based on the first block, is prevented from being applied to the first electronic payment method.

17. The computing device of claim 15, wherein the memory storing instructions that, when executed by the one or more processors, further cause the computing device to:
receive, based on second user input to the user device and at the first server, an indication to cancel a second subscription of the one or more subscriptions, wherein the second subscription is associated with a second merchant;
send, from the first server to a third server associated with the second merchant, a request to cancel the second subscription;
institute a second block, wherein the second block is configured to stop incoming transactions for the second subscription;
receiving, at the first server and for the first electronic payment method, a second incoming transaction;
apply the second incoming transaction to the electronic payment method;
detect, using the machine learning model, that the second incoming transaction is a subscription transaction for the second subscription and was not blocked;
reverse the second incoming transaction from being applied to the electronic payment method; and
update, based on the second incoming transaction, the machine learning model.

18. The computing device of claim 15, wherein the memory storing instructions that, when executed by the one or more processors, further cause the computing device to:
causing display of, on the user device and by the first server, an option to reactivate the first subscription.

19. The computing device of claim 18, wherein the memory storing instructions that, when executed by the one or more processors, further cause the computing device to:
receiving, based on second user input to the user device and on the first server, and indication to reactivate the first subscription; and
sending, from the first server to the second server, a request to reactivate the first subscription.

20. The computing device of claim 15, wherein the memory storing instructions that, when executed by the one or more processors, further cause the computing device to institute the first block by:
updating, based on the first incoming transaction, the machine learning model.
